(19) United States
(12) Patent Application Publication
(10) Pub. No.: US 2026/0199893 A1
(43) Pub. Date: Jul. 16, 2026

(54) CHIPLET PRODUCTION AND METHODS OF USE

(71) Applicant: AtlasXomics Inc., New York, NY (US)

(72) Inventors: Joseph C. GENNARO, New Haven, CT (US); Zev KARTIGANER, Easton, CT (US); Gumaro ROJAS, New Haven, CT (US); Silas DECKER, New York, NY (US); Matthew EASTMAN, New York, NY (US); Dan MASSUCCI, New York, NY (US)

(21) Appl. No.: 19/131,520

(22) PCT Filed: Nov. 20, 2023
(86) PCT No.: PCT/US23/80497

§ 371 Date: May 20, 2025

Related U.S. Application Data
(60) Provisional application No. 63/427,050, filed on Nov. 21, 2022.
(60) Provisional application No. 63/427,052, filed on Nov. 21, 2022.

(51) Int. Cl. B01L 3/00

(52) U.S. Cl. CPC B01L 3/502707; B01L 2300/0887

(57) ABSTRACT

Methods and apparatus for the creation and use of chiplets loaded with different reagent embedded in gel carrier materials are described herein. The chiplets are created using a microfluidic device. The reagents embedded in the gel carrier materials are drawn through channels of the microfluidic device and then fixed in place within the microfluidic device. After fixing the reagents in place, generally by a reduction in temperature, one or more chiplets are separated from a region of interest portion of the microfluidic device. The chiplets can then be packaged and sold to end-users for various that would traditionally require microfluidic devices. End-user can then affix one or more of the chiplets to a sample without needing to perform a microfluidic flow operation.

### CROSS-REFERENCE TO RELATED APPLICATIONS

This application claims priority to U.S. Provisional Patent Application Ser. No. 63/427,050, entitled “CHIPLET PRODUCTION AND METHODS OF USE”, filed Nov. 21, 2022, and to U.S. Provisional Patent Application No. 63/427,052, entitled “CHIPLET PRODUCTION AND METHODS OF USE,” filed Nov. 21, 2022. The contents of each of these applications are incorporated herein by reference in their entirety.

### BACKGROUND

### Field

This disclosure is generally related to the production and use of chiplets created using a microfluidic device. More specifically, channels of the microfluidic device can be loaded with a hydrogel impregnated with active ingredients intended to be applied onto a target substrate. This transforms the microfluidic device into a substrate with demarcated reagent's separated by a channel boarder. These chiplets can improve spatial resolution and precision compared to flowing reagents through a microfluidic device and over a target substrate. Furthermore, chiplets can be cut or diced to shape or produce multiple chiplets from a single chiplet.

### Related Art

Microfluidics can be applied to perform many different applications. One particular application of microfluidics, known generally as Deterministic Barcoding in Tissue for spatial omics Sequencing (DBiT-seq), entails placing an array of thin, empty channels made of silicone on top of tissue, pressing them down in a uniform and precise manner to create a seal against the tissue surface without collapsing the channel walls, then pumping reagents through the channels, thereby washing reagents in precise geometric areas on the tissue section. In practice this delivers sufficient active ingredients (e.g., oligonucleotides, enzymes, fluorophores, collectively referred to as “reagents” from here on) to carry out an array of spatialized omics techniques such as spatial transcriptomics for mapping messenger RNA (mRNA), spatial proteomics for mapping a panel of proteins, spatial epigenomics for mapping chromatin accessibility and/or histone modifications, and various combinations thereof.

### SUMMARY

One embodiment can provide a microfluidic chip whose microfluidic channels are filled with a set of distinctly-loaded hydrogel strips. Each strip could hold one of a series of reagents, e.g., an oligonucleotide with a specific sequence indicating channel number, or a concentration of a reagent in a titration screen. After being delaminated from the flow substrate, the microfluidic chip so loaded (herein called a “chiplet”) can then be used as a stamp to deliver the active ingredients to the target substrate (in a preferred embodiment, a tissue section mounted on a coated glass slide) in a spatially determined manner.

In another embodiment, the chiplet can be freed from the inactive regions of the microfluidic device (e.g., by cutting it). This allows the active area of the chiplet to significantly increase. Furthermore, this largely eliminates the limitation of the size of the microfluidic chip's outer perimeter. More importantly, this permits the ability to dice the chiplet into multiple chiplets (similar to semiconductors) where the time per chiplet, and therefore cost, can be further reduced.

A method for producing a chiplet is described and includes the following steps: securing a flow substrate directly to a microfluidic chip comprising a plurality of channels; concurrently flowing a first reagent embedded in a first gel carrier material through a first channel of the plurality of channels and a second reagent embedded in a second gel carrier material through a second channel of the plurality of channels; adjusting one or more material properties of the first and second gel carrier materials disposed within the plurality of channels to restrict further movement of the first and second reagents within the microfluidic chip; and optionally cutting the microfluidic chip into a plurality of pieces to produce at least a first chiplet, wherein the first chiplet includes a first portion of the first channel and a second portion of the second channel, wherein the first and second portions of the first and second channels included in the first chiplet extend from a first end of the first chiplet to a second end of the first chiplet.

In one embodiment, the microfluidic chip can be tailored to increase its affinity of the hydrogel (e.g., increase the hydrophilicity of the microfluidic channels).

In another embodiment, the gel can be tailored to increase its affinity to the microfluidic device (e.g., increase its hydrophobicity).

A method for utilizing a chiplet is described and includes the following steps: applying a chiplet to a tissue sample, wherein the chiplet comprises a plurality of parallel channels extending from a first end of the chiplet to a second end, opposite the first end, the plurality of channels comprising a first channel filled with a first reagent embedded in a first gel carrier material and a second channel filled with a second reagent embedded in a second gel carrier material; clamping the chiplet to the tissue sample; increasing the temperature of the chiplet to allow the first and second reagents to flow on to and interact with the tissue sample; and removing the chiplet from the tissue sample after a predetermined incubation time.

A chiplet is disclosed and includes the following: a first substrate defining a plurality of channels, wherein the plurality of channels extend from a first end of the substrate to a second end of the substrate opposite the first end, a first reagent embedded in a gel carrier material that fills a first channel of the plurality of channels; a second reagent embedded in the gel carrier material that fills a second channel of the plurality of channels; and a second substrate covering the plurality of channels.

### BRIEF DESCRIPTION OF THE FIGURES

The patent or application file contains at least one drawing executed in color. Copies of this patent application publication with color drawing(s) will be provided by the Office upon request and payments of the necessary fee.

FIG. 1 shows a successful flow in a 50 channel 25 micron microfluidic chip;

FIG. 2 is a schematic depiction of flow-based (left) and chiplet-based (right) processes for delivering spatial barcodes to tissue sections

FIGS. 3A-3C show imagery of three different 50-channel 25 um chiplets captured for quality inspection following delamination.

FIG. 4A shows an exploded view of a caselet.

FIG. 4B shows a perspective view of a chiplet disposed in the caselet depicted in FIG. 4A.

FIG. 5 shows active vs non-active area of a DBiT-seq microfluidic device.

FIGS. 6A-6B show delivery of fluorescently labeled oligonucleotide to two different fresh-frozen mouse embryo sections.

FIG. 7 shows four electropherograms from the head-to-head comparison of multiple spatial-ATAC-seq runs.

FIGS. 8A-8D show TIXEL maps of fragment counts from head-to-head comparison of two flow-based spatial-ATAC-seq runs and two matched chiplet-based runs.

FIG. 9A shows a table with comparative sequencing statistics between the matched flow-based and chiplet-based runs.

FIGS. 9B-9E show more results for a chiplet-based DBiT run.

FIG. 10 shows a microfluidic chip with a “SuperChip” design featuring 288 separate inlets.

FIG. 11 shows an image of a microfluidic chip with a MotherChip design configured to produce multiple chiplets.

FIG. 12 shows a common way of mounting multiple tissue sections on one slide.

FIG. 13 shows a microfluidic chip with a serpentine design.

FIG. 14 shows an intensity plot from the region inside the dashed square in FIG. 13.

FIG. 15 shows another microfluidic chip with a “MotherChip” design.

FIGS. 16A-16B show a configuration in which a tissue sample is positioned between an A and B chiplet.

FIGS. 17A-17B show methods for depositing barcoded gel on a solid substrate.

FIG. 18 shows an application of electrophoresis to transport active ingredient from the gel carrier into the target substrate.

FIGS. 19A-19C show relative cycle time data for DBiT operations.

FIGS. 20A-20B show electropherograms for a number of different chiplet-based DBiT runs.

FIGS. 21A-21C show exemplary sequenced datasets generated using chiplet-based processing.

FIGS. 22A-22G illustrate comparisons of chiplet-based runs and standard DBiT-ATAC-seq runs performed on tissue sections from the same specimen blocks.

FIG. 23 depicts side by side comparison data of ATAC DBiT-seq data collected from tissue sections from the same tissue block (Mouse Hippocampus and Mouse Cerebellum).

FIG. 24 demonstrates spatial whole transcriptome and ATAC data co-profiled on the same tissue sections using chiplets.

FIG. 25 shows chip-on images of fluorescently impregnated barcode reagent over a printed cell matrix on a glass slide.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein can be applied to other embodiments and applications without departing from the spirit and scope of the present disclosure. Thus, the disclosed system is not limited to the embodiments shown, but is to be accorded the widest scope consistent with the principles and features disclosed herein.

### INTRODUCTION

When a microfluidic chip is engaged on a substrate (such as a tissue section) with clamping pressure typically in the range of 0-50 pounds per square inch (PSI), each of the channels of the microfluidic chips are generally formed or defined by three walls of PDMS or Silicone and another wall of tissue/glass. The resulting channels range from 10×10 um up to 50×50 um in cross-section. The channels are generally arranged in parallel and in an ideal situation liquid carrying one or more reagents is drawn through each of the channels of the microfluidic chip with no flow irregularities.

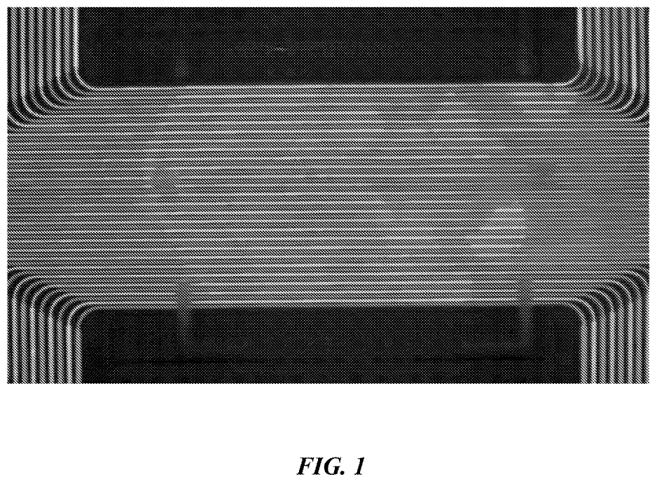

FIG. 1 shows a successful flow in a 50-channel 25×25 um chip (meaning there were 50 channels, each with a cross section of 25×25 micrometers). The reagent flowed here was a 30-nt ssDNA oligonucleotide conjugated with one of two fluorophores, red (Cy3) and green (FAM). The chip was clamped onto a mouse embryo tissue section mounted on a poly-L-lysine (PLL) coated glass slide.

While the example in FIG. 1 shows that block- and leak-free flow over a range of tissues and tissue preparation modalities using a 25 um microfluidic chip is possible, in many cases, typically due to uncontrollable variation in how tissue is sectioned and mounted, the “perfect flow” (all channels flowing, and no channels leaking into one another) escapes even our most skilled operators. In production runs (i.e., spatial-ATAC-seq) the fraction of channels displaying good flow (neither a leak nor a block) for a 25 um microfluidic chip is closer to 97% using state of the art methods and equipment.

Now consider a 10 um microfluidic chip. It delivers a quasi-cellular spatial resolution highly sought after in the industry but at the steep cost of sacrificing flow performance. However, at this high resolution approximately half of flow tests and full DBiTs with high quality 10 um chips suffer significant flow irregularities, defined as >5% of channels with leaks or blocks.

One solution to this performance issue is to stop flowing over tissue. While DBiT-seq, as it is currently practiced, does wash reagents across tissue, this is not the defining feature of the technique. The defining feature is delivering reagents to a substrate in a geometrically precise manner, then using combinations of those geometrical shapes to combinatorially generate distinctly labeled regions. This holds true no matter how one deposits the liquid, whether via microfluidic chip, tiny paint bush, or whatever other method achieves satisfactory isolation of the right reagents to the right locations.

The DBiT-seq microfluidic chip, at its heart, is a tool to print fine lines of active reagent on rough substrates. We determined that line widths of 10 um, and even 5 um or smaller, which when cross-printed result in areas of 10×10 um, 5×5 um, or even smaller are well within the capabilities of the DBiT microfluidics platform when not attempting to print on a rough substrate. Therefore, we determined that by filling a DBiT-seq chip's microchannels, on a smooth substrate, with an appropriately barcoded hydrogel in liquid phase, then we can optionally extract one or more portions of the pre-loaded microfluidic chip that include those portions of the microchannels that would normally contact a tissue sample to create a stamp or as we call it in this description, a chiplet.

This insight resulted in the development of the embodiments described herein. The embodiments provide biologists with a user-friendly way to apply reagents to tissue sections with cellular precision and minimal chance for imprecise barcode application. Unlike standard DBiT-seq, biologists need not perform any microfluidic operations typically practiced by skilled operators in optimal conditions. It also removes the need to wash liquid across tissue; instead, the chiplet-filling occurs in idealized conditions on smooth substrates. Later, the chiplets are removed from the smooth substrate, inspected for quality, and then stamped onto tissue. Rather than asking biologists to manually flow each barcode matrix, we have created a veritable printing press for spatial omics barcoding.

### Flow in Factory/Stamp in Lab

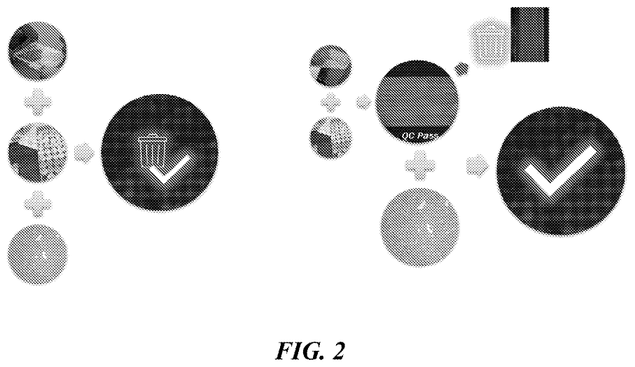

The described embodiments split up the process of printing reagents onto tissue into the following steps: (1) Fill chiplets with reagent-impregnated gel; (2) Delaminate chiplets from a flow substrate, check for quality, then store and ship to end-user; and (3) End users unpackage chiplets and interfaced them with their substrate of choice. This process is schematically depicted in FIG. 2.

FIG. 2 is a schematic depiction of flow-based (left) and chiplet-based (right) processes for delivering spatial barcodes to tissue sections. In the chiplet-based process, microfluidic chips are filled with barcoded gel at a chiplet factory. After flow and removal of the chiplet from the smooth flow substrate, it is visually inspected for quality. Chiplets that do not meet the quality threshold are discarded. This has the effect of reducing manufacturing yield; however, it shields valuable tissue and biologist/lab time from imperfect barcode arrays. Chiplets that pass inspection are packaged and shipped to end users who use them to stamp barcode arrays onto their substrate of choice.

This compartmentalization stands in stark contrast to the conventional flow-based DBiT-seq method, which demands that the end-users themselves flow liquid through the chips in adverse conditions, resulting in frequent flow irregularities which reduce the quantity and/or quality of data derived from a particular sample. Every time a flow occurs (twice per sample), all the resources dedicated to that sample's successful analysis are put at risk. Poor flow outcomes waste tissue, reagents, lab time, biologist time, and entire experimental designs in cases where the tissue is precious and irreplaceable. Even discounting the cost of tissue, these costs can amount to one thousand dollars or more per sample assayed. When dealing with precious, irreplaceable tissue sections, these costs may be incalculable, and deserve the best chance possible at producing high-quality biological data.

The described embodiments create chiplets in a flow-friendly environment using the following exemplary steps: (1) Interface a fresh, clean microfluidic chip with the flow substrate. (2) Pre-heat the chip/slide assembly on a hot plate to ≥37° C. (3) Meanwhile, heat up a 96-well PCR plate, with 50 of the wells filled with a barcode-gelatin mixture. (4) The appropriate barcode-bearing gel is pipetted into each well. Then, vacuum is used to pull barcode-bearing gel through each channel of the microfluidic chip. The gel is flowed through the channels at a pre-determined vacuum pressure (typically between −40 to −80 inches of water) for a pre-determined amount of time (typically between 2-10 minutes) until the barcode-bearing gel uniformly fills the channels inside a region of interest (i.e. portion of the microfluidic chip that would conventionally contact a tissue sample). (5) The gel is then allowed to cool (either passively, or actively using ice, dry ice, being placed inside of a refrigerator, or interfaced with any cold substrate) and solidify inside the channels, either before or after turning off the vacuum. (6) The flow substrate is then delaminated from the filled chiplet, and the chiplet is visually inspected (in an epifluorescence microscope) to check for any defects in the active area. (7) Chiplets with no defects are stored and set aside for later use. Chiplets with defects are discarded.

It should be noted that in some embodiments, the flow substrate can remain against the microfluidic chip and only be removed once a customer is ready to utilize a chiplet. In such a case the chiplets can be formed by cutting the microfluidic chip and flow substrate concurrently. Alternatively, the party responsible for creating the chiplet can delaminate the flow substrate from the chiplets and then cover the channels of the chiplets with another protective layer to prevent contamination of the reagent contained within the channels.

In some embodiments the microfluidic chips (or chiplets) are made from a hydrophilic material or treated to make the microfluidic surfaces hydrophilic to reduce flow resistance and increase the bond between the gel and the chip (or chiplet).

Compared to flowing on tissue as in normal DBiT, there are typically fewer blocks, and leaks during chiplet filling. This is because the flow substrate is known at this stage (e.g., blank glass). This performance improvement was observed with 10 um, 25 um, and 50 um resolution chips, and observed on one test with a 5 um resolution chip. This improvement is achieved because without tissue or another rough substrate fouling up the flow, there's very little reason why a channel shouldn't conduct liquid-phase gel from one end of the chip to another. In the case of a glass slide with no tissue as the substrate, we can clean it very quickly and aggressively, ensuring there is no debris remaining to confound flow.

To the extent any flow failures do occur, they reduce manufacturing yield and consequently cause a negative economic effect. Such errors can still occur due to bubbles or defects in the microfluidic chip (granted, at an extremely low rate, since we pipette carefully and manually screen chips for defects). Regardless, an effective quality control step shields the rest of the downstream assay from flow failure, and if the approximate yield is known, it can be corrected for by over-manufacturing by a factor of one divided by an expected yield.

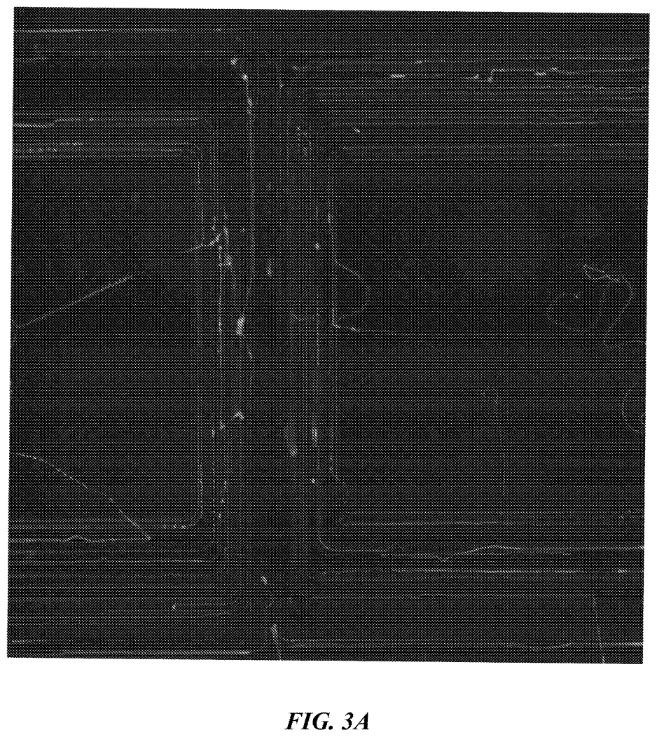

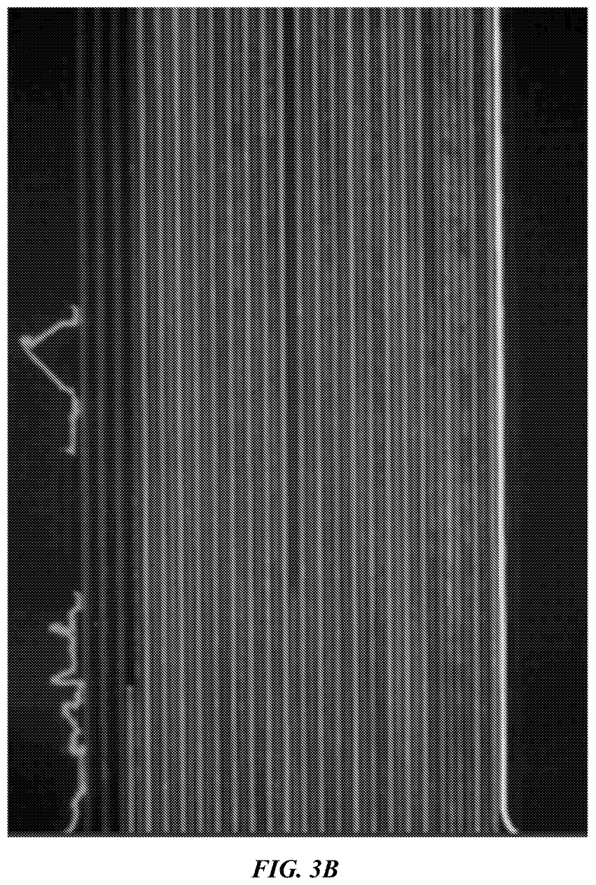

It should be noted that before a chiplet can be interfaced with tissue, it must first be removed from the flow substrate it was flowed on. This step introduces another manufacturing failure mode, typified by the gel strips adhering as well or better to the flow substrate than they do to the PDMS walls forming the microchannels of the chiplet. Such failure modes are observable by inspecting the delaminated chiplet in a microscope. “Spaghettification,” or strips being pulled out of the channels, and either being missing or splayed out across the channels in disarray, results in a failed chiplet, which is tossed. Examples of spaghettification can be seen in FIGS. 3A-3C.

FIGS. 3A-3C show imagery of three different 50-channel 25 um chiplets captured for quality inspection following delamination. The gel is impregnated both with active reagent and either a red (ROX) or green (FITC) inert fluorescent dye to indicate gel presence or absence. The images are generated by imaging the chip after delamination from the substrate via dual-color epifluorescence microscopy. In particular, FIG. 3A shows a failed delamination wherein most of the strips of gel were torn out of the microchannels. FIG. 3B shows a failed delamination, where strips of gel towards the left side of the region of interest were ripped out of the microchannels. This chiplet would be discarded before it interfaced with tissue. FIG. 3C shows a successful delamination, where all gel strips were retained in the chiplet. Note the lone empty lane in the chiplet shown in FIG. 3C never received gel due to a known chip defect, meaning this chiplet had 49 out of 49 possible successes.

An optimized protocol for minimizing spaghettification and maximizing the manufacturing yield upon delamination includes the following steps: (1) Seal the microfluidic chip to be filled with gel on a smooth, non-adsorbent flow substrate before flowing; (2) Cool the chip after filling an ROI of the chip with gel at 0-4° C. for 15 minutes; (3) allow condensation to clear from the chip and/or flow surface by introducing the assembly to temperature around 23° C. for 0.5-1 minute, 1-5 minutes, 1-15 minutes or 1-60 minutes depending on the composition of the carrier gel material and reagents being used; (4) Peel the flow substrate off of the chip (or the chip off the flow substrate); (5) Check the chip in a microscope to look for spaghettification, regions devoid of barcoded gel, or regions containing overlapping barcoded gels (analogous of blocks and leaks); (6) If irregularities are present above a certain quality threshold, discard the chip. If not, store in a durable fashion (perhaps inside a caselet), binned by quality.

In some embodiments the chiplets are stored with their initial flow substrate intact.

In some embodiments the flow substrate is removed from the chiplet prior to storage and the chiplet is protected from debris with a caselet and/or a laminate.

In some embodiments, chiplets are stored in a humid environment by enclosing the chiplet with a humectant in a sealed system such as a pouch or caselet.

In some embodiments, chiplets are stored dried out by storing in a dry environment or lyophilizing then gel (freeze drying).

In some embodiments, chiplets are stored at −20° C. In other embodiments, chiplets are stored at 4° C. In some embodiments, chiplets are stored at room temperature. In some embodiments, chiplets are stored at within a range of temperatures from −20° C. to room temperature.

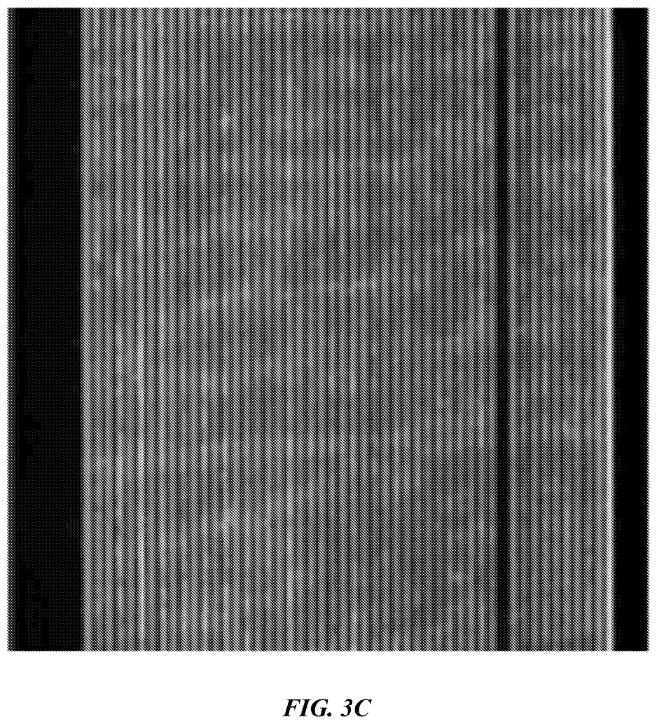

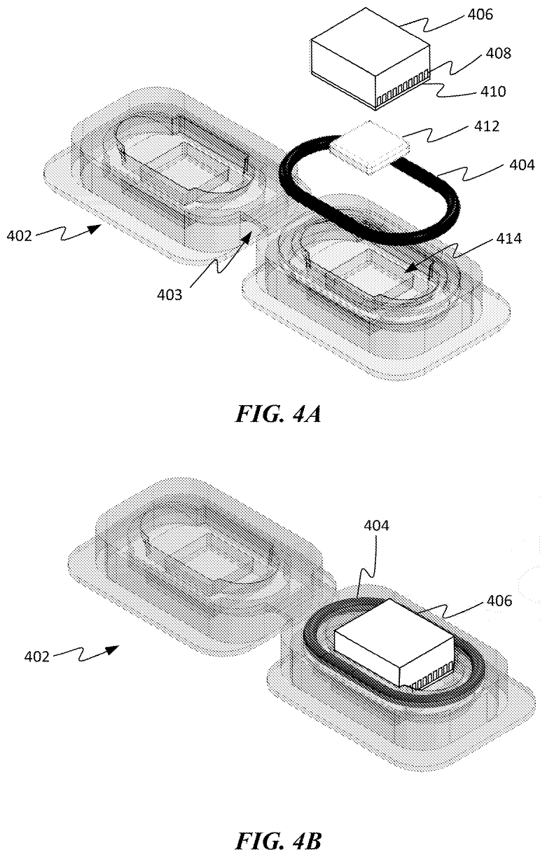

FIGS. 4A and 4B show views of an exemplary caselet 402 for storing a single chiplet.

The caselet is designed with a living hinge 403, hence why there is a cavity on both sides of the caselet. However, the caselet can be designed to hold any number of chiplets (e.g., 2, 4, 8 or some other even number likely to be convenient for an end user). Each caselet can also be packaged within a larger box/case, which is then also sealed to be watertight and airtight. It should be noted that the living hinge, 403 is not required for the design to work; rather it is a feature to reduce cost (one molded piece rather than multiple). A caselet can also have a design more similar to a conventional piece of two-piece storage container (e.g., food storage container) if preferred. At a high level, a caselet is designed to provide an enclosed environment for one or more chiplets to be stored in that also allows for an easy way to unpackage and use the chiplets stored therein, while reducing risk of damage or degradation.

FIG. 4A shows an exploded view of exemplary caselet 402 with an environmental seal or gasket 404 removed. FIG. 4A also depicts a chiplet 406 with exemplary channels 408 filled with reagents dissolved in a gel carrier material (e.g., a hydrogel or solgel). It should be noted that channels 408 are oversized here for exemplary purposes only and that typically a chiplet would include 25-300 channels. A protective layer 410 is shown protecting the material contained in channels 408 until chiplet 406 is ready for use. Protective layer can take many forms including that of a layer of PET or glass. FIG. 4A also shows humectant 412, which is configured to fit within recess 414 of caselet 402 and prevent the material within channels 408 of chiplet 406 from drying out. FIG. 4B shows chiplet 406 disposed within caselet 402 and gasket 404 positioned in place to prevent the intrusion of air into caselet 402 once caselet 402 is closed.

Flow-based DBiT processes require the use of two different styles of chips, A and B chips. They differ only in the orientation of the channels in the active area. Sequential application of and flow through an A chip followed by a B chip produces DBiT's characteristic orthogonal crossflow schema.

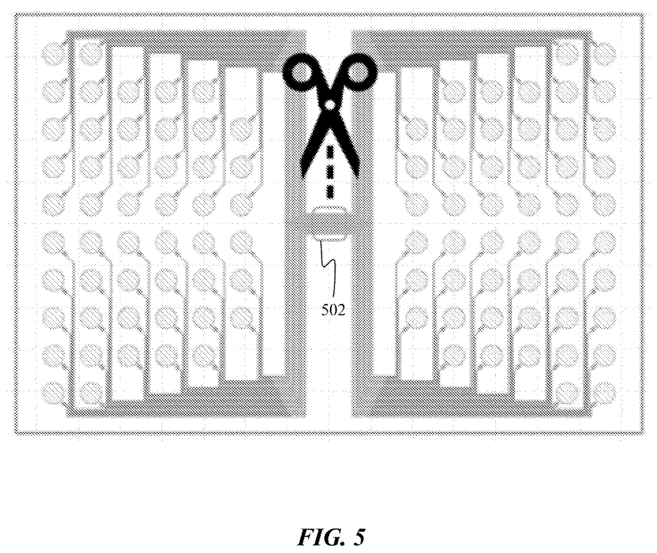

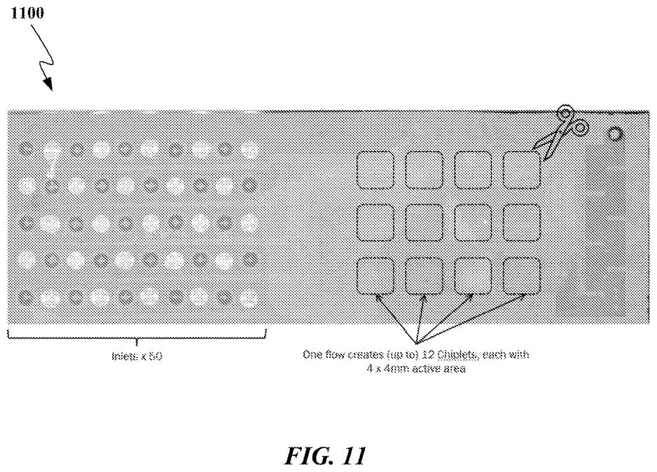

FIG. 5 shows active vs non-active area of a DBiT-seq microfluidic device. The area inside the small orange square 502 is active, and everything else is inactive. After filling the chip with a barcoded gel and solidifying the gel, everything outside square 502 can be cut away and discarded as waste. This enables A- and B-orientation chiplets to be manufactured on the same chip design, rather than requiring two separate manufacturing lines as is currently the case. Note how much of the barcode would be wasted if each inlet were filled completely and flowed to the outlet side; for every 10 microliters of barcode mix loaded into the chip, only approximately 20 nanoliters or so (or 1/5000th of the loaded barcode) is required to fill the active area. Later we will see how to use this fact to reduce barcode waste. In some embodiments, a microfluidic chip can be designed specifically for the production of multiple chiplets from a single microfluidic chip (see FIGS. 11 13, and 15).

Below are some of the main failure modes encountered while using our preferred method of filling Chiplets. The prevalence of each mode depends on the method chosen for fabrication. Delamination is described below and can be minimized by proper choice of flow substrate and enhancing the affinity of the gel to the microfluidic channels. Bubbles formed inside the gel during flow during the filling phase can be minimized by using a microfluidic chip without any sharp angles and clean of all debris and other sharp surfaces likely to act as a bubble generator. Condensation can occur after delamination of the chiplet when the chiplet is below room temperature and/or in a very humid environment. Condensation often results in mixing of active ingredients between channels. Condensation can be avoided by only delaminating chiplets at or near room temperature and in a controlled-humidity environment. A final failure mode is more subtle and occurs when short flow times are used to produce chiplets. This can result in varying concentrations of active ingredients between channels in the active area of the microfluidic device. Stamping with an uneven chiplet resulting from the varying concentration could cause excessive technical variation in the downstream assay. Uneven loading can be identified by conjugating a fluorescent molecule (i.e., a fluorochrome) to the active ingredient, either in the chiplets to be used as stamps, or test chiplets flowed in identical conditions to those that would be used as stamps. To avoid uneven loading, flow the gel for long enough (2-10 minutes in most configurations) so that the concentrations asymptote to their equilibrium value (i.e., the concentration of active ingredient in the active area and inlets should be made as similar as possible).

When filling the chip with gel to make a chiplet, the choice of a flow substrate can strongly affect the outcome in at least these ways: (1) How well do the microfluidic chip and flow substrate passively seal to one another? The better they seal without clamping, the easier it is (mechanically speaking) to fill the chip with gel without any leaks (gel from one lane entering another lane inappropriately). While it is possible to use flow substrates that don't passively seal well to the microfluidic chip, the two must be clamped tightly to prevent leaks. (2) How much does the flow substrate material resist flow? The use of flow substrates with highly hydrophobic surfaces can require larger vacuum pressures when drawing reagent embedded liquid gel through the channels of the microfluidic chip to overcome the water-soaked liquid gel's distaste for coating hydrophobic surfaces. Consequently, the use of flow substrates with highly hydrophobic surfaces can also encourage the formation of bubbles. (3) How hard is it to peel the chiplet off the flow substrate after flow (or, in some cases, peel the flexible flow substrate off of the chiplet) without tearing the strips of gel out of the channels of the chiplet? Materials that bond well to gel (such as uncoated glass) tend to cause more “spaghettification” (see FIGS. 3A and 3B for examples). This lowers manufacturing yield and increases the effective unit price. (4) How expensive is the flow substrate? Expensive substrates increase unit prices.

Given the above considerations, here are several flow substrates that have been tested, in decreasing order of likelihood of delamination and flow success. (1) Polycarbonate (PC) or Poly Ethylene Terephtalate (PET) sheet, between 100-500 um thick. The plastic surface resists attachment to gel, passively bonds to the PDMS to enable flow, and is not overly hydrophobic. The flexibility of the sheet enables peeling of the substrate off of the chiplet at an extremely obtuse angle (almost 180 degrees) which helps the gel strips stay inside the chiplet. (2) PFOCTS (1H,1H,2H,2H-Perfluorooctyl-trichlorosilane)-coated glass slides, fabricated in a vacuum jar (venting to a chemical hood) via vapor deposition. (3) RainX-coated glass slides, a commercial spray coating fabricated in our lab via repeated spraying and wiping of a blank glass slide with Kimwipes.

A variety of other materials can also serve as flow substrate in some conditions and for some carrier gel materials. The following have been tested as flow substrates: poly-L-lysine-coated glass slide, silanized wafer, aluminum, polystyrene, thin film PDMS, FEP (Fluorinated Ethylene Propylene) thin film, Polyether ether ketone (PEEK), high-density polyethylene (HDPE), thin film Polytetrafluoroethylene (PTFE), and polyimide (PI) have been tested as flow substrates. Additional flow substrate candidates include: cellulose, PP and PLA.

An exemplary DBiT procedure can be performed by an end user using two stored chiplets. The procedure includes the following steps: (1) unpackage a first stored chiplet. The unpackaging process can include a controlled thawing procedure to avoid situations in which the barcode embedded gel is prematurely liquified or condensation is deposited on the first stored chiplets active surfaced (causing barcodes to communicate with each other via diffusion through condensed water droplets). (2) after preparing a tissue sample, now also deposit 100-200 microliters of ligation buffer on the tissue sample. (3) Let the buffer incubate on the tissue sample at RT for 15 minutes. (4) Pour off excess buffer but do not dry the tissue sample completely. (5) Place the chiplet on the tissue in the desired location and orientation. (6) Clamp the chiplet down on the tissue sample. (7) Control the temperature of the chiplet and tissue sample while the barcode embedded gel interacts with the tissue sample during a fixed incubation period of time. (8) Remove the chiplet from the tissue sample after a desired incubation period of time (e.g., 2, 4, or 16-24 hours). (9) Wash the tissue in warm wash buffer (37° C.) to remove excess remaining gel. (10) Repeat each of the previous steps for a second stored chiplet. The second stored chiplet will generally be placed in the same location that the first chiplet was placed with an orientation causing the channels of the second chiplet to be orthogonal with respect to the orientation of the channels of the first chiplet.

In some embodiments, the ligation buffer is added to the pre-loaded chiplets. Thus, rendering steps 2-4 as optional.

In some embodiments, the chiplet is not clamped to the tissue. Rather lateral diffusion is permitted within the tissue. We have performed tests such as this, and in the case of uniformly dense regions of interest, the diffusion rate between channels is approximately equal; thereby increasing the tagged area of that barcode by a channel wall thickness worth. The result is limited-to-no dead space between channels; which would normally be accompanied by the channel walls. Based on our experiments, the barcodes diffuse to the analytes and hybridize primarily to those that are unoccupied by a pre-hybridized/ligated barcode.

The following notes apply to the above exemplary DBiT procedure: (1) there's no risk of flow failure because there is no flow, only stamping. (2) one way to precisely locate the region of interest for placement of the second chiplet is to use fluorescently-conjugated Bovine Serum Albumin (BSA), with one color in channel 1 (for example, green, using FAM or a similarly-colored fluorochrome conjugated to BSA) and another color in the last channel (for example, red, using Cy3 or a similarly-colored fluorochrome conjugated to BSA). Any colorant can be used to mark the outer lanes, but BSA has the advantageous property of binding non-specifically to a variety of biologics, including components of tissue, a common substrate, and poly-L-lysine (PLL), a common biologic coating applied to the surface of glass slides to encourage binding between the slides and the tissue mounted on them. Even if part or all of the outer lanes don't traverse tissue, they will still deposit a recognizable line of color on the flow substrate, thereby still successfully demarcating the extent of the active area of the applied chiplet. (3) The clamping pressure is consistent with normal DBiT processing, meaning chiplets applied use any of the variety of clamps that work for normal DBiT. (4) Longer ligation times are possible at room temperature or cooler with the described embodiments but not with normal DBiT. This is because the gel remains solid and barcode transfer is mediated by diffusion from the gel matrix into the tissue. We have observed minimal barcode diffusion between channels even in overnight ligations, meaning that long, slow ligations are now possible. In normal DBiT chips, incubations of longer than 1 hour are ill-advised for chips that incorporate passive common outlet technology due to the increased frequency of reagent diffusion between channels as it spends more time sitting inside the chip.

It is of interest to determine how the quality of downstream sequenced data generated with the described embodiments compares to that produced by standard flowing. Considering that the non-spatial-barcoding steps between the two methods are similar, we considered whether stamping was likely to transfer enough active ingredient (in the case of DBiT, oligonucleotides serving as distinct combinatorial spatial barcodes for downstream NGS) to a region of interest (ROI) in the tissue.

Chiplet-based DBiT processing exposes the tissue to less reagent than does a normal DBiT operation in which barcoded reagent is flowed over tissue. A DBiT chip inlet holds up to 10 uL of liquid, and in principle one could flow the entire 10 uL across the tissue, exposing the tissue to an integrated volume of aqueous solution containing a very large amount of active ingredient. For example, 10 uL of 5 micromolar solution holds 3×10¹³ oligonucleotides. In practice approximately 2-5 uL are typically delivered to the outlets of each channel, but even 10%-50% of this number is a very large number of oligos.

The described embodiments, in comparison, don't move liquid along the lane; rather only the volume of gel directly above the ROI is capable of delivering active ingredient to the ROI. Suppose the length of the channel in the ROI is about 5 mm for a 10 um chip. The volume of this channel is about 10 um×10 um×5000 um=0.5 nanoliters. For a 5 micromolar solution of oligos, this yield “only” gets about 1.5 billion oligos in each lane. Assuming a cell-cell spacing of 10 um, 5000 um spans about 500 cells. Meaning each cell gets about 3 million oligos at most (some probably don't make it out of the gel and into the tissue).

Is this enough? For some rough comparisons, the number of fragments we typically recover in a spatial-ATAC-seq run is about 50,000-100,000 fragments of tagmented gDNA per tixel in a 25 um run. For spatial-Whole-Transcriptome, we recover 3000-5000 UMIs per tixel. Table (1) below summarizes the math reviewed here and includes parameters useful for calculating the oligonucleotide availability per analyte in spatial-ATAC-seq and spatial Whole Transcriptome flavors of DBiT-seq at the indicated chip resolutions

TABLE 1

| Parameter | 10 um chip | 25 um chip | unit |
|---|---|---|---|
| Barcode molarity | 5.00E−06 | 5.00E−06 | M |
| A | 6.02E+23 | 6.02E+23 | # |
| Length | 5000 | 5000 | um |
| Width | 10 | 25 | um |
| Height | 10 | 25 | um |
| L/um3 | 1.00E−15 | 1.00E−15 | # |
| Volume | 8.5E−10 | 3.125E−09 | L |
| # oligos | 2.56E+09 | 9.41E+09 | # |
| Tixel spacing | 10 | 25 | um |
| Tixels/ROI | 500 | 200 | # |
| Oligos/tixel | 5.12E+06 | 4.70E+07 | #/tixel |
| ATAC gDNA frags/tixel | 25000 | 75000 | fragments/tixel |
| ATAC Oligos/fragment | 205 | 627 | #/fragment |
| WT UMIS/tixel | 1000 | 5000 | UMIs/tixel |
| Oligos/UMI | 5120 | 9410 | #/UMI |

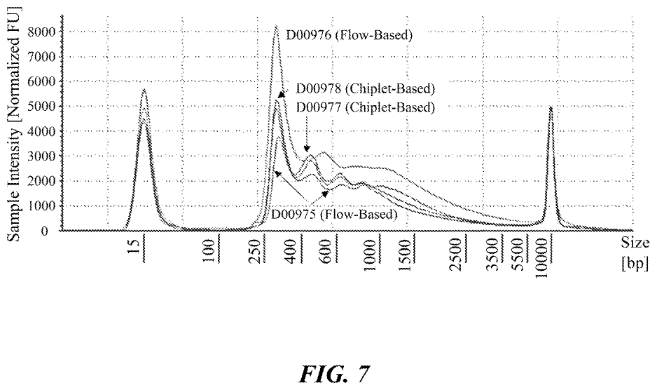

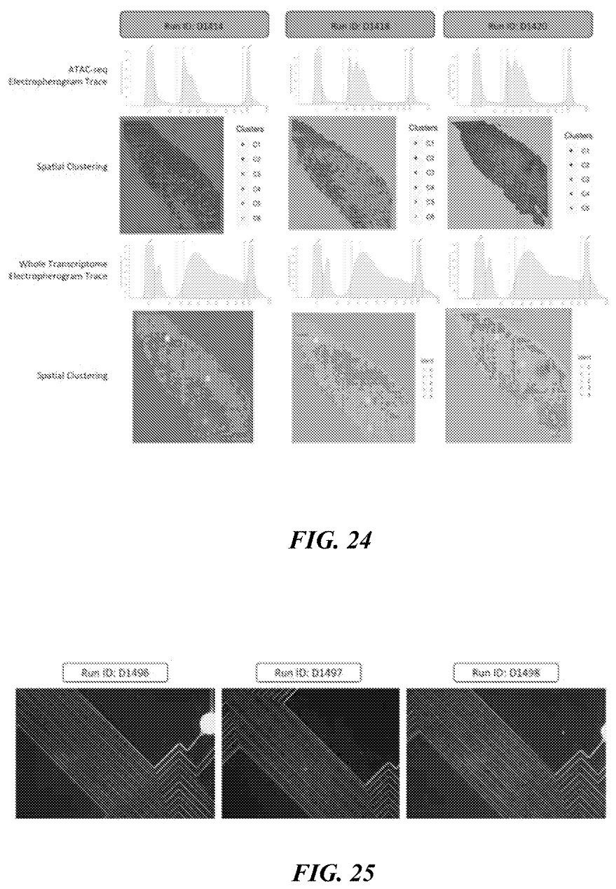

Based on the above table, there is more than 5000 available barcodes per UMI in the 10 um configuration and more than 9000 available barcodes per UMI in the 25 um configuration. Similarly, there is more than 200 and 600 available barcodes for every fragment in the 10 um and 25 um configurations respectfully. Although this ratio is much lower than that of the flow-over-tissue method, we do not see a reduction in quality in the chiplet based DBiTs shown herein (e.g., FIGS. 7-9, and 20-24). FIG. 24 includes co-profiling ATAC and WT examples as well, which would further reduce the number of available oligos per analyte to 197 [5.12E+06/(25000+1000)] or 588 [4.70E+07/(75000+5000)] for the 10 um and 25 um configurations respectfully. The number of available oligos available can easily be increased by growing the height of the microfluidic channels or simply adding a higher concentration of oligos in the gel.

The demonstrated chiplet-based DBiT processing entails soaking the tissue with approximately 120 microliters of ligation buffer (a mix of T4 ligase buffer, water, NEBuffer, T4 DNA Ligase, and Triton X-100) before placing the chiplet on the tissue. This provides T4 ligase in abundance in a non-spatially controlled way. Since the enzyme is identical in all lanes, it need not be delivered in a spatially controlled way. And since the ligase is a protein complex (around 80,000 daltons) it is larger than oligonucleotide (our barcodes are around 68-75 nucleotides (nt), or around 20,000 daltons), and therefore more likely to have a concentration gradient along the length of the flow channel. This innovation of providing the ligase enzyme in bulk has been demonstrated to work with the standard DBiT protocol.

Comparative Data Quality between Chiplet-Based and Standard DBiT Processing

To demonstrate the feasibility of using the chiplet-based DBiT processing to deliver active ingredients to a target substrate, we conducted three sequential studies. (1) Active ingredient delivery. First, we sought to establish whether a chiplet can deliver fluorescently labeled oligonucleotide barcode to a pre-prepared tissue section. (2) Tuning process parameters for spatial-ATAC-seq. Next, we performed some full spatial-ATAC-seq DBiT experiments using chiplet-based DBiT processing instead of the standard flow method and compared the data with the body of data derived from standard spatial-ATAC-seq experiments performed on similar tissue samples (but not matched samples). Using this data (summarized below) we tuned some of the processing parameters for the chiplet-based DBiT processing method, including (but not limited to): a. Delamination conditions b. Ligation incubation times and temperatures c. Composition of the ligation buffer, including the salt content. (3) Head-to-head comparison. Third, using the optimized processing parameters derived from the second flight of experiments, we performed a head-to-head comparison of two standard and two chiplet-based DBiT-seqs on Mus Musculus cerebellum tissue, where the Mus Musculus cerebellum tissue was snap-frozen and embedded in optimal cutting temperature compound (OCT).

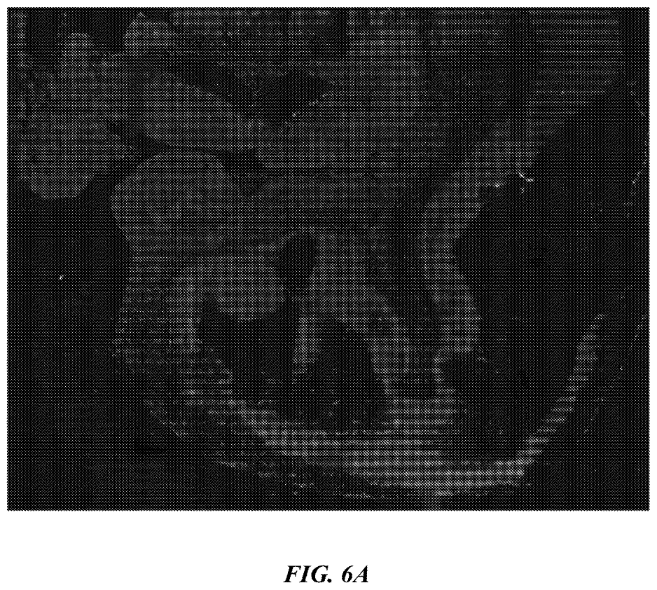

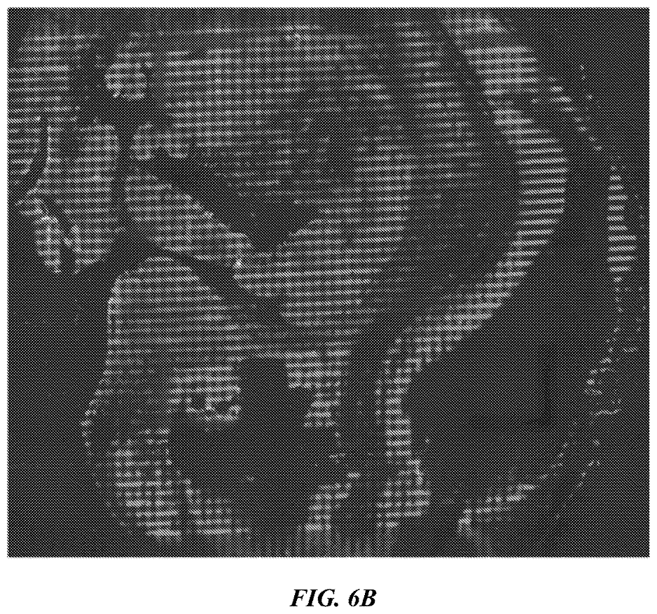

FIGS. 6A-6B show delivery of fluorescently labeled oligonucleotide to two different fresh-frozen mouse embryo sections. The sections were thawed, fixed in 4% PFA, and underwent permeabilization and reverse transcription, which generates cDNA (complementary DNA) using cytosolic mRNA (messenger RNA) as a template. The resulting priming site was used as a target site for hybridization and sticky-end ligation (via T4 ligase) of a ssDNA (single-stranded DNA) barcode via a fluorescently-labeled oligonucleotide linker (green columns, FAM label). A chiplet was used to deliver the labeled oligos and linkers. After A-stamping and ligation incubation, the tissue was washed in warm NEB 3.1 buffer and subjected to an orthogonal stamping, incubation, and washing of similarly labeled linkers and oligos with the array oriented in an orthogonal direction (red rows, Cy3 fluorophore), except this time the oligo hybridized and ligated to the previous oligo rather than the cDNA target. The ligation condition in FIG. 6A was a two-hour incubation at room temperature and in FIG. 6B was a two-hour incubation at 37° C. Based on the lower frequency of non-specific binding in the room-temperature incubation depicted in FIG. 4A, that condition was preferred in subsequent optimization testing.

Utilizing the method demonstrated above, we set to demonstrate the viability of conducting full spatial-ATAC-seq and spatial-Whole-Transcriptome-seq (spatial-WT-seq) via chiplet stamping rather than flowing barcodes. Based on our results of approximately 12 successful DBiTs carried out using chiplets, our preferred protocol used the following process parameters: (1) same barcode concentration as in standard DBiT; (2) ligation at 16° C. for about 16 hours, or room temperature for 10 minutes followed by 37° C. for at least 2 hours; and (3) using identical composition of the ligation buffer as in standard DBiT, except that the buffer is soaked onto the tissue prior to stamping (rather than delivered via the microfluidic channels as in standard DBiT).

Using the processing parameters described above, we set out to directly compare chiplet-based DBiT processing to standard DBiT processing performance on the same day, with four sections from the same Mus Musculus cerebellum tissue sample, cut and mounted on the same day. The sections were stored at −80° C. until the day of the experiment, at which point they were thawed, fixed, and primed with Tn5 tagmentase by the same technician, using enzymes and barcodes diluted from the same master batches, using ligation buffer prepared according to the same recipe and on the same day by the same technician. All this represented our best attempt to eliminate any variation between samples except for the experimental condition, that two of four runs were conducted with the standard flow protocol in 25 um resolution single-layer microfluidic chips, and the other two runs were conducted with 25 um resolution chiplets.

Despite longer ligation incubations generally yielding superior chiplet-based processing results than shorter ones, we elected to perform a uniform ligation across all four runs (10 minutes at room temperature followed by 37° C. for 30 minutes) in order to normalize temperatures and times between the two conditions in order to best discern any difference in barcode delivery efficiency between the methods.

The performance of the four runs was largely comparable, except that the standard flow runs showed slightly less variation correlated with row and/or column number. This indicates that the fragment recovery rate, at equal concentrations and equal ligation temperatures and times, was slightly lower for FlowGel (chiplet based processing) than for standard DBiT. Despite this, by most metrics the runs are statistically indistinguishable at N=2 replicates. To reduce the rate of row/column aligned artifacts in the fragment counts, the barcode concentrations could be increased in the carrier gel of the chiplets, and the ligation temperature and the ligation time could be optimized for the technique (i.e., room temperature for 2 hours, 4 hours, or 16 hours).

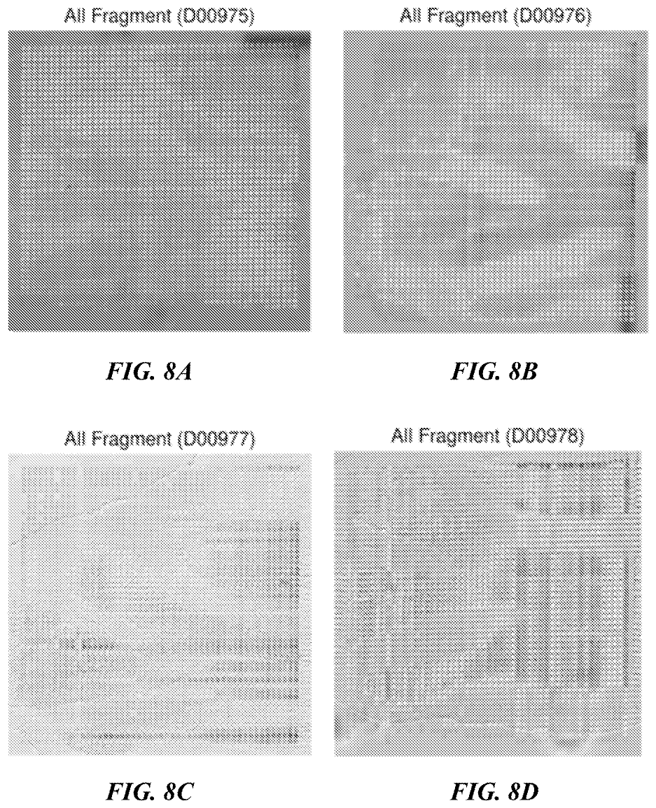

FIG. 7 shows four electropherograms from the head-to-head comparison of two normal spatial-ATAC-seq runs (D00975/D00976) with two matched chiplet-based spatial-ATAC-seq runs (D00977/D00978). FIG. 7 shows a fragment length distribution from each of the four runs, with the nucleosome-free peak (between 270 and 425 base pairs) and subsequent peaks spaced at 147 base pairs demonstrating good agreement with expected ATAC-seq signal in all four runs. The mononucleosome (270+1*147) and dinucleosome (270+2*147) peaks look more well-separated in the chiplet-based runs shown in FIGS. 8C and 8D.

FIGS. 8A-8D show TIXEL maps of fragment counts from head-to-head comparison of two matched flow-based spatial-ATAC-seq runs (FIGS. 8A-8B) and two matched chiplet-based runs (FIGS. 8C-8D). Though the chiplet-based runs displayed a higher degree of artifacting related to channel-channel variation in barcode delivery, all four runs display a similar level of homology between fragment counts and tissue morphology. It should be noted that each of the squares in the TIXEL map for the chiplet-based runs corresponds to intersection points of the channels of the first chiplet with the channels of the second chiplet, which as discussed above has it's channels oriented orthogonally with respect to the channels of the first chiplet.

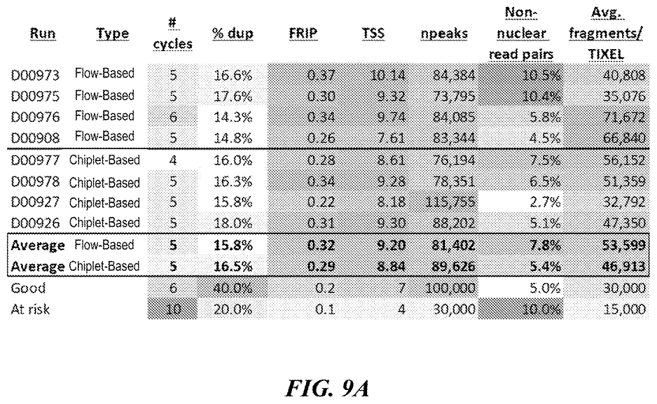

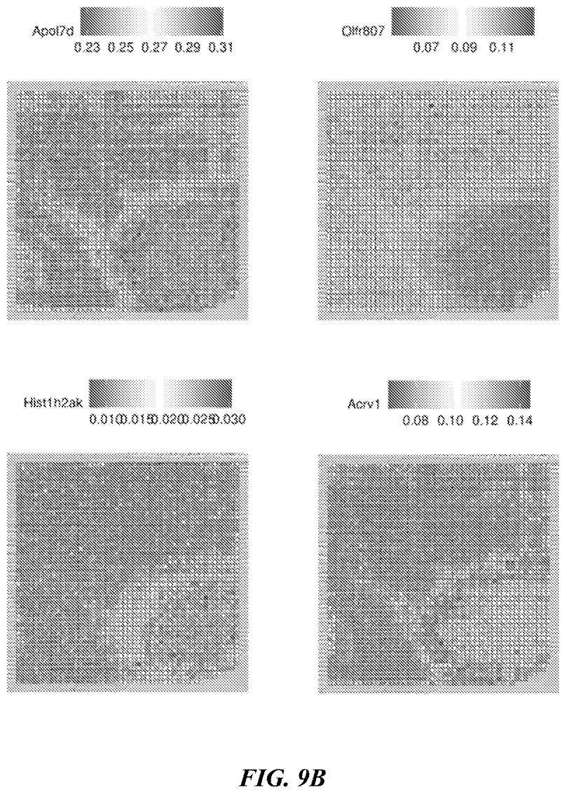

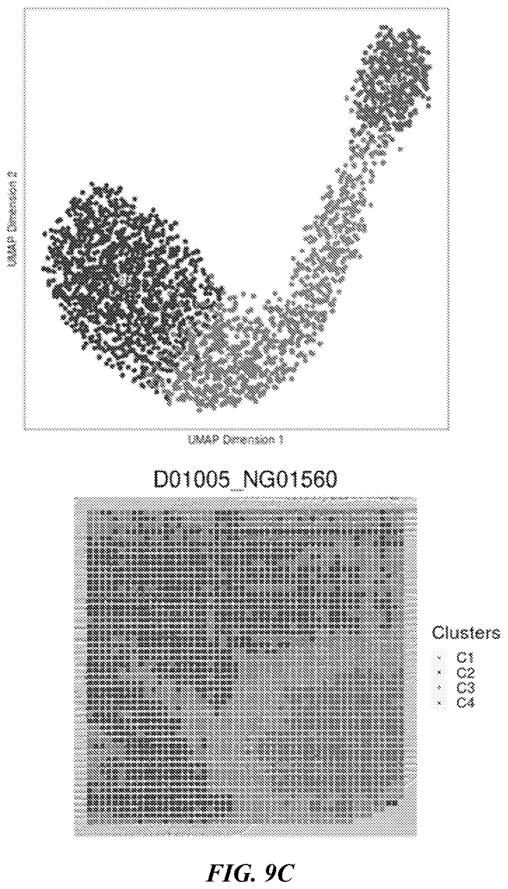

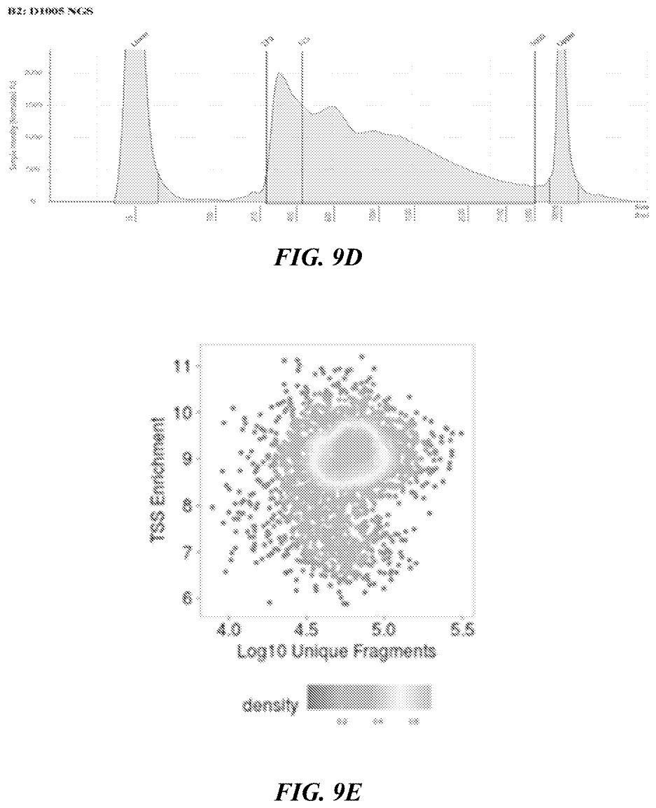

FIG. 9A shows a table with comparative sequencing statistics between the matched flow-based and chiplet-based runs. Definitions: #cycles=additional PCR cycles determined via qPCR amplification of library aliquots. The total amplification cycles is equal to 5+the # of additional cycles. % duplicates=number of sequenced reads which duplicated one another (higher numbers indicated deeper sequencing and/or less diverse library). FRIP=fragments of reads in peaks (higher score better). TSS=transcription start site enhancement score (higher score better). Npeaks=number of peaks found in the gene tracks. Avg. fragments per TIXEL indicates the average number of fragments recovered per on-tissue TIXEL. The values in the two bottom rows (“Good” and “At risk”) indicate the thresholds for a standardized sequencing metrics scoring rubric. The relative values indicate whether higher or lower values are desired in each category. Each of the runs shows metrics within the parameters used by those skilled in the art of chromatin profiling, except for runs D00973 and D00975, which display abnormally high non-nuclear read pairs. This can indicate that something related to flowing (e.g., the vacuum pressure applied to the channels while engaged with the tissue) disrupts compartments filled with non-nuclear sources of genomic DNA (e.g., mitochondria) in a way that chiplet stamping does not (since no vacuum is applied to the chiplet while engaged with the tissue).

FIGS. 9B-9E show results for a chiplet-based DBiT runs. FIG. 9B depicts the fragment recovery rate for regions of the genome associated with the genes Apol7d, Olfr807, Hist1h2ak, and Acrv1. Of particular note is the lack of any technical artifacts marring the spatial distribution of these markers, which matches the tissue morphology visible in brightfield microscopy.

FIG. 9C shows the results of unsupervised spatial clustering which separates TIXELs (tissue elements) into groups driven by differences in the genomic profiles of recovered fragments. The upper panel shows the UMAP (uniform manifold and approximation projection) plot corresponding to this clustering schema. This representation of the data in a dimensionally reduced space is well-known to those skilled in the art, and the better the separation between TIXELs in this representation, the richer the data set.

FIG. 9D shows an electropherogram from an Agilent TapeStation which shows the fragment length distribution of the fragment library that was sequenced to generate the images in FIGS. 9B and 9C. The large first peak at 270-400 base pairs is consistent with the typical separation between histones in chromatin, signifying a meaningful tagmentation via Tn5 transposase took place in the tissue sample.

FIG. 9E simultaneously depicts the TSS (transcription start site) enhancement score with the amount of recovered fragments in each TIXEL. The good circularity of distribution is evident of high library quality. The population of somewhat lower TSS scores (below TSS 8) represents a region of lower chromatin accessibility, which is visible in FIG. 9C as cluster 4.

It should be noted that the chiplet-based processing methods described herein result in substantial workflow savings in terms of the amount of time lab technicians need to actively spend to perform a DBiT processing. Real-world testing shows that hands-on technician times can be reduced by a factor of three. For example, measured hands-on time for technicians using 25 um resolutions was reduced from about 2.2 hours to 0.6 hours in testing. It should be noted that the use of chiplet-based processing can still result in an increase in the overall time taken to perform DBiT processing due to increased ligation times. However, the reduction in hands on time allows technicians to attend to other tasks, such as performing more chiplet based DBiT-seq while waiting for ligation to finish.

### Performance Improvements (ROI & Resolution)

Since flow for chiplet-based processed occurs a) without risking tissue and b) on a known, flat substrate, longer flow paths can be carried out without risk of flow irregularities or tissue damage. Increases in resolution are much simpler to achieve with chiplet-based processing than with flow-based processing since there is no substrate heterogeneity or non-smoothness to account for when flowing during creation of the chiplet. The flow proceeds exceptionally well at resolutions down to 5 micrometer channel width. By contrast, flowing on tissue experiences severe issues starting at around 10 micrometer channel width. This enables spatial assays with spatial resolution down to 5 um or less with FlowGel.

Unfortunately, shrinking the channel widths to improve spatial resolution has the side effect of decreasing field-of-view when maintaining a fixed number of channels. From a biological perspective, this increases spatial bias when selecting the region of interest. In particular, the typical 50-channel chip used in DBiT shrinks its active area from 2.5×2.5 mm at 25 um resolution to 1×1 mm at 10 um resolution, and further shrinks the active area to 0.5×0.5 mm and Sum resolution. These fields of view are too small for many end users, and therefore it would be of great practical utility to the field to enlarge the active area of the chip.

Another side effect of reducing the width of the channels in the ROI is that the amount of barcode proximal to the ROI (and capable of diffusing into the tissue in the ROI) has reduced. For example, a 10×15 um channels has a cross-sectional area of 150 square micrometers, compared to 25×25=625 square micrometers in a typical 25 um channel. This is a reduction in area, and therefore volume, and also therefore oligonucleotides per target tissue element (“tixel”), of 76%. This can be ameliorated slightly by increasing the height of the channels in the high-resolution chip, e.g., from 10×15 um to 10×17.5 um. This has dual purpose: 1) Higher channels will hold on to more gel during delamination (more contact area with PDMS vs. flow substrate), and 2) the cross-sectional area in the ROI will increase from 150 sq um to 175 sq um, or only 72% decreased compared to the 25 um resolution chip.

Though this sounds like large decrease, the area underneath the channel has also decreased, and therefore the number of targets that require barcodes also decreases (in proportion with the area of the tissue element, or tixel). E.g., a 25 um tixel has 625 sq um lateral area, while a 10 um tixel has a 100-um lateral area (lateral in this context meaning in the plane of the tissue section).

The reduction in field of view issues can be ameliorated in the following ways with chiplet-based processing: (1) Add more channels to enlarge chiplets; (2) Place multiple chiplets on the same substrate.

A drawback of adding more channels is that additional space must be allocated on the chip for both inlets and outlets to provide interfacing ports with the additional channels. Inlets interface with the liquid loading implement (e.g., a single or multi-channel pipette), while outlets interface with the vacuum providing the pressure gradient that enables flow.

One way to alleviate the need for additional space for outlets is to merge lanes after they pass through the active area; this strategy is hereafter referred to as the “common outlet” plan. This saves space by reducing the number of separate outlets present in the chip. It also introduces a contamination-type failure mode whereupon if active ingredients mix after their respective lanes have merged, and subsequently those mixed active ingredients flow, diffuse, or are otherwise delivered backwards into the active area, the chip can fail to restrict each active ingredient to its intended target delivery area on the substrate.

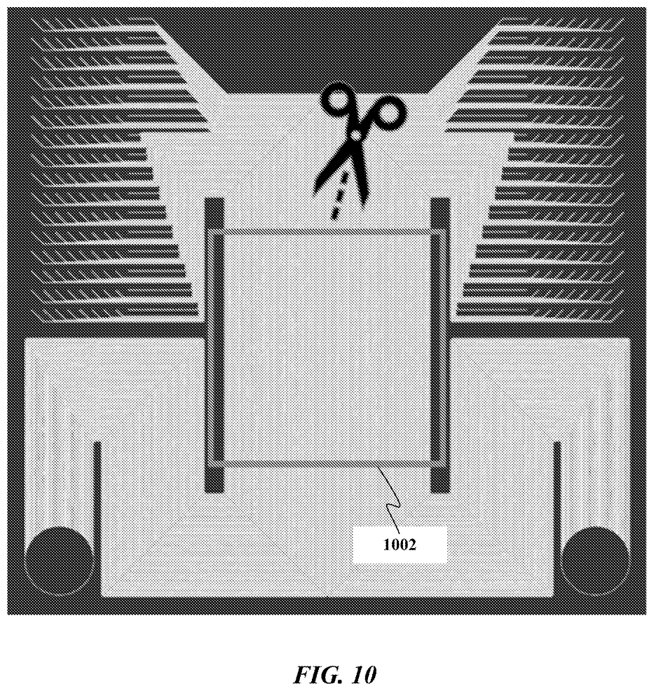

FIG. 10 shows a “SuperChip” which features 288 separate inlets. Each of the 288 inlets feeds one channel passing through the active area. After passing through the active area, the channels merge into two groups, each group terminating in a single common outlet. The space saved by omitting 208 of 210 possible outlets has been used to add more channels, enabling a larger field of view. In the case of this particular SuperChip with 10 um channel width and 15 um spacing, the active area spans a width of 288×(0.010+0.015)=7.2 millimeters. If two such chips were cross-flowed or cross-stamped to create a DBiT region of interest, this would generate field of view of 7.2×7.2 mm, or 51.8 square millimeters, which is 51.8× bigger than the current DBiT 10 um field of view of 1×1 millimeters.

Since only the active area (denoted by square 1002) needs be stamped onto tissue, it can be cleaved from the rest of the chip (making a chiplet), stored, and delivered to the end user. An identical chip can be filled with differently barcoded gel (e.g., with a set of B rather than A barcodes), cleaved into a chiplet, and stamped on a substrate (which has already been stamped with an array of barcodes by an A chiplet) with an orientation rotated relative to the previously stamped array (such as 90 degrees, or any other chosen rotation) to enable a fully-functional DBiT assay at 10 um resolution with a very large field of view.

Such a chip could in principle be used to enable standard-flow DBiT. However, two problems would arise. First, the chip would have to be clamped in two orientations on the substrate in order to achieve crossflow, and existing hardware does not permit a chip with such a footprint to be clamped in two different orientations on the same substrate. Second, a single-layer chip with so many channels would experience an enormous amount of flow irregularities at 10 um resolution, since there is a large amount of active area with thin channels. The resulting high flow resistance due to long, narrow channels would pose significant problems, requiring high vacuum pressure and potentially resulting in many more blocked or crosses channels than is usual for smaller chips. Thirdly, during the ligation times (between approximately 0.25 hour-24 hours) called for by most DBiT protocols, reagents would mix in the common outlets and back-propagate to the active area, contaminating channels with incorrect barcodes and lowering the spatial fidelity of the assay. Methods for reducing such back propagation include the use of valves to restrict back flow or diffusion, as well as vacuuming simultaneous to incubation.

When used to produce a chiplet for chiplet-based processing, this chip design has none of these problems, neither when filling the chiplet nor when stamping the chiplet on tissue. First, the chiplet can be cleaved from the rest of the chip and placed in any manner or orientation desired by the end user. Second, the chip need not be clamped on the flow substrate during filling since there are no uneven spots to seal over. Therefore, there will be few flow irregularities, and if there are any those deformed chiplets can be tossed out before touching tissue. During stamping, the viscosity of the gel at room temperature or cooler ligations inhibits back-propagation of the barcode from the common outlets to the active area.

Furthermore, this style of chip is easier to manufacture and cheaper to operate than current DBiT double-layer chip designs (as described in U.S. 63/328,195, “MICROFLUIDIC CHIP”). It is a single-layer chip, making it easier to manufacture than a double-layer chip, which requires separate fabrication of the two layers, followed by alignment, bonding, and visual inspection of the two layers (compared to no alignment and no bonding for single-layer chips).

Lastly, there are no separate manufacturing lines for A and B chips, compared to two manufacturing lines for A and B-style double layer flow chips. This results in significant cost savings for fabricating the SuperChip and filling chiplets as compared to fabricating double-layer A and B chips and flowing them on tissue. In all, chiplet-based processing enables a much denser design of chips than does the standard flow-based approach, and this type of chip with such a large active area will enable researchers desiring single-cell resolution profiling of target analytes to do so with less spatial bias and while capturing greater proportions of tissue samples of interest.

FIG. 11 shows an image of a microfluidic chip 1100 with a MotherChip design configured to produce multiple chiplets. Microfluidic chip 1100 has a 50 um channel resolution in the active area. Each well holds Sul of carrier gel. The common outlet (hole in the top right) is far enough away from the active areas (depicted by dotted squares) that any mixing of carrier gel will not contaminate active areas. After flow at 37° C. the entire apparatus is cooled to room temperature, fixing the gel in place. Before delamination a cryotome blade was used to cut the chiplet to test whether the cutting process would foul the ends of the chiplets (bottom). This did not occur, demonstrating the feasibility of creating many chiplets from one MotherChip. This design creates up to 12 4 mm×4 mm active areas from one flow, meaning each active area would cost 1/12th of a 50-channel double-layer DBiT active area chip. This also reduces the oligo cost per active area significantly; from 6 uL/channel to 5 uL/channel/12 chips. This serpentine chip costs approximately the same to manufacture as a current single layer chip, which is about $100. Meanwhile a double-layer chip currently costs approximately $250. Since each chip supports 12 runs, this reduces the microfluidic chip cost from 2×$250=$500 per run to 2×$8.33=$16.66 per run. This style of chip would be much more difficult to execute with flow-based DBiT processing, as all the active areas would need to be created in series on tissue, increasing the likelihood of flow irregularities, with each block or leak obscuring or polluting the downstream TIXELs-to-be. This becomes of greater importance as the channel size reduces to resolutions relevant to the market (i.e. 10 um or smaller).

In some use cases, end users would prefer to have multiple fields of view on the same substrate, rather than maximizing the area of one field of view. This is the case, for example, in tumor microarrays or other use cases whereupon multiple distinct tissue sections have been mounted onto the same glass slide.

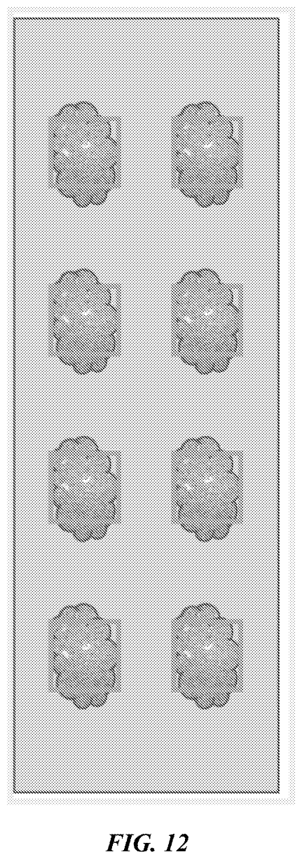

In order to address this use case, we can leverage the capability to cleave the active area of a chiplet from the rest of the microfluidic device used to create the chiplet, then place a pair of chiplets (A and B) in each intended field of view. This scenario is depicted below in FIG. 12. Each dashed line represents a field of view the end user would like to spatially profile. In this case the tissue sections are evenly spaced on a 2×4 grid; however, there is no need in principle for the chiplets to be arranged on a regular grid. This greatly eases the job for the histo-technologist who is tasked with thinly slicing and precisely mounting eight or more tissue sections on one substrate in small, pre-defined areas; the technologist can do their best to mount the sections with sufficient space between them to place chiplets, and then the precise placement (and rotation) of the chiplets can be chosen at run-time to adapt to the placement of the sections.

The configuration shown in FIG. 12 is a common way of mounting multiple tissue sections on one slide (e.g., for a tumor microarray). Histo-technologists using chiplet-based processing no longer would be forced to accurately mount these tissue sections in pre-defined locations since the number, rotation and location of the chiplets are chosen by the end user at run-time.

After sequential A & B stamping, each field of view now has 210×210=44,100 TIXELs, each with a distinct A & B barcode. Normally the end user would then have to lyse each of the eight fields of view separately then use distinct primers during next-generation sequencing library preparation, in order to enable sample pooling downstream without mixing up targets from different fields of view.

Chiplet-based processing enables an even easier method, however. Wherein each of the eight A chiplets contains a different set of 50 A barcodes (e.g., A1-A50, A51-A100, A101-A150, A151-A200, A201-A250, A251-A300, A301-A350, and A351-A400). Meanwhile there is only one set of B barcodes in each of the identical eight B chiplets. Now suppose all fields of view, after A&B stamping, are digested in the same lysis buffer. The resulting pool of lysates are then subjected to the same purification and library amplification steps, and sequenced. This will result in there being 8×210×210=8×44,100=352,800 TIXEL units in the downstream analysis, with groups of 44,100 TIXEL units each corresponding to the appropriate regions of each tissue sample, just as designed in U.S. 63/252,091, METHODS AND DEVICES FOR SPATIALLY ENCODED BIOLOGICAL ASSAYS. This method is superior to the ones described there, however, for reasons described below.

In order to facilitate handling and placement of chiplets during manufacturing and end-use, a graspable feature could be included in each chiplet. For example a short stretch of wire could be suspended into the liquid PDMS and retained during curing so that one end of the wire is embedded in an area of the resulting microfluidic chip that is configured to be removed to form a chiplet. This works so long as the wire is secured above the contact layer, thereby avoiding interfering with active ingredient delivery. While an example of a wire is provided other graspable features are also deemed to be within the scope of the described embodiments (including but limited to the surface tension adhesion between the back of the chiplet and a temporary support and/or clamping bar). This type of feature would be of increasing importance as the number and/or density of chiplets increases, as densely-spaced chiplets would be difficult to grasp from the sides without disturbing neighboring chiplets.

Standard DBiT requires a very thin tissue section (between 5 um and 10 um thick) in order to generate successful crossflow on tissue. Since chiplet-based processing does not flow in tissue, it does not require thin tissue sections. In principle it has no maximum tissue thickness, and could even stamp barcoded gel onto non-flat sections. For example, the flexible PDMS chiplet could stamp the surface of an intact organ (rather than an organ section). This enables two important embodiments.

DBiT on vibratome sections. Vibratome sections (around 40 um thick or thicker) can't be used for most microscopy techniques due to the opacity of the thick tissue section. However, chiplets could be used to stamp barcodes on top of the section, regardless of thickness. This would open up spatial omics or other barcode-driven assays to those without access to a crytotome, helping democratize spatial omics.

DBiT in 3-D. Consider an intact entire organ, such as a mouse brain. Cut it in half to generate a somewhat flat surface where the cut was made. Apply A & B chiplets to the flat surface. After barcode transfer, cut off the barcoded surface layer of the brain (say the top 50 um of it), then repeat the process for the newly exposed flat surface. Repeat until the entire brain has been thusly barcoded. Combination of the 2-D omics profiles in silico will generate a 3-D profile of the brain at high throughput and low cost. The best format of tissue for this method would be tissue that has been fixed via perfusion so as to avoid needing to fix each section separately.

DBiT on tissue sections suspended in a matrix. It can prove beneficial to suspend a tissue section in a gel matrix or other matrix (e.g., for tissue clearing or for expansion microscopy). This would enable higher sensitivity and/or higher resolution spatial profiling with existing microfluidics. For example, a 10 um resolution barcode array stamped on a 5× expanded section would have the same resolving power on expanded tissue as would a 2 um resolution chip, which is sub-cellular in many tissue types. Expanded tissues would be suspended in one of a plethora of polymer gels. In order to be thin enough to be compatible with standard DBiT, the embedded tissues may need to be re-sectioned after embedding and/or expansion, with a 10 um thick section having only about 2 um thicknesses-worth of pre-expanded targets in it, making it possible that standard DBiT would recover sufficient information. For example, cell nuclei may be absent or only partially intact in the resulting thin slice, reducing the quality of epigenetic profiling in such regions of the tissue. Chiplet-based processing would not require re-sectioning, making it more easily compatible with tissue embedding-based approaches.

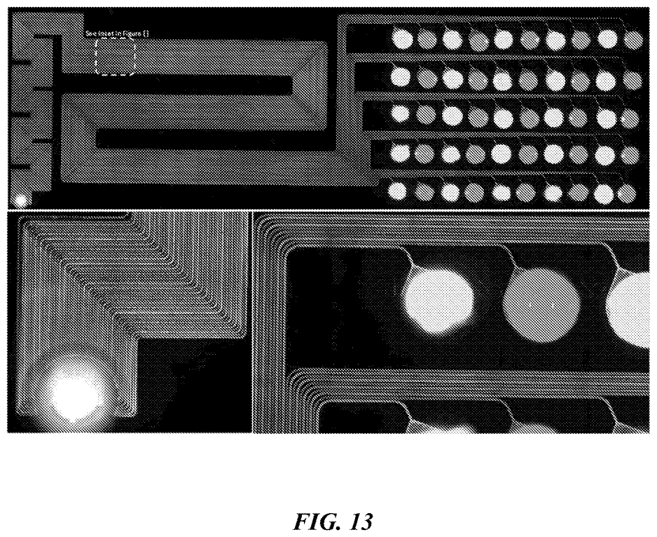

As previously described in reference to FIG. 11, in order to further reduce the fabrication cost of chiplets, we can create a “MotherChip” which uses one set of inlets to feed multiple active area's worth of downstream channels. In our initial testing with a serpentine chip with 50 um channels in the active area (pictured below in FIG. 13, we did not encounter any bubbles. We attribute this to the lack of sharp corners or edges which disrupt flow and encourage the formation of bubbles in earlier version of our chips.

FIG. 13 shows a microfluidic chip 1300 with a serpentine design having 50 inlets (far right), 50 micron channels with 30 micron separation between channels, and one common outlet. The chip is made from PDMS and the laminate is a polycarbonate thin film. The barcoded gel (even channels loaded with Cy3 conjugated to a 50-mer random ssDNA barcode, odd channels loaded with FAM conjugated to a 50-mer random ssDNA barcode) is kept molten on a hot plate during flow. After flowing for 10 minutes at −60° C. in H2O, the assembly is allowed to cool to room temperature, and was then stored in the refrigerator at 4° C. overnight inside of an unsealed petri dish. The next day the laminate was peeled off and the entire chip imaged in two-color fluorescence, revealing that barcode concentration uniformity was high, all the way through to the delay loop (far left). Despite all channels merging in the common outlet (yellow circle, bottom-left), back-propagation of the contaminating barcode only traversed a few mm, keeping the active areas safe from barcode mixing (inset, bottom). This chip consumes a total of 5 uL×50 channels=250 uL, which is half of that consumed by a standard, single layer DBiT chip (500 uL) per region of interest. Since this chip can be diced into approximately nine chiplets, the oligo usage is 1/18th of a standard DBiT, saving 94% of the barcode cost on a per-ROI basis.

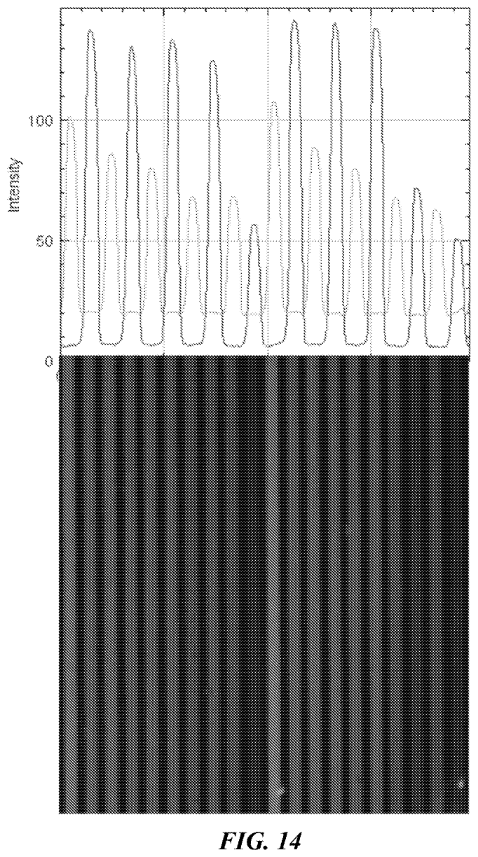

FIG. 14 shows an intensity plot from the region inside the dashed square in FIG. 13, showing how near the distal end of the serpentine pattern, lanes exhibit decreased active ingredient concentration (measured in this case by fluorescence signal) resulting from some channels' inlets being located closer to the active area than other channels. This sort of concentration gradient would result, upon stamping, in uneven deposition of active ingredient to the target substrate and can be avoided by flowing barcoded gel in the chiplet for longer durations or at higher pressures in order to swap out the chemical gradient variations caused by the differential channel lengths.

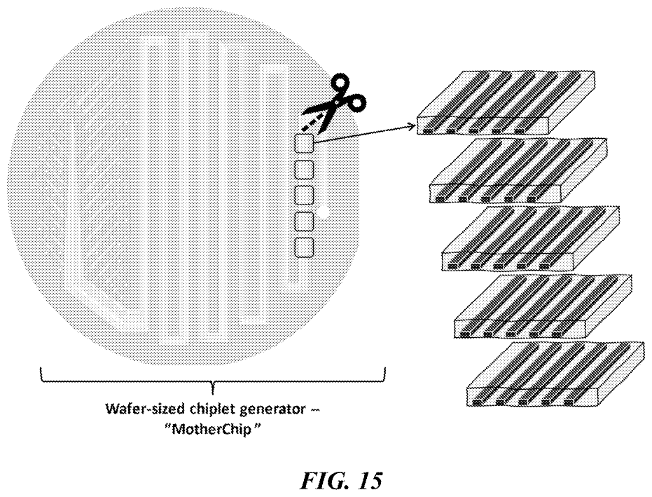

FIG. 15 shows a microfluidic chip 1500 with another “MotherChip” design illustrating how to use one set of inlets and one microfluidic chip to fabricate a large number of chiplets in one microfluidic flow process. After loading the inlets with barcoded gel and flowing the liquid gel forward through as much of the chip as possible, the gel is fixed in place and the chiplets cleaved from the rest of the MotherChip with a razor blade. The process has the ability to generate tens or hundreds of chiplets simultaneously, thereby enormously reducing fabrication cost and time. It especially helps reduce the time and expense related to delamination, since the entire MotherChip can be frozen, thawed, and delaminated together before cutting it up into chiplets.

### Sacrificial Flow Substrate

Another variation of the described embodiments includes the use of a sacrificial flow substrate. A process for using a sacrificial flow substrate would include at least the following steps (1) flow molten carrier gel through the microfluidic chip using a PVA thin film as the follow substrate; (2) cut out the inactive areas of the microfluidic chip; and (3) place the chiplet on a tissue section moistened with PBS and/or a ligation buffer that cause the PVA thin film to dissolve, thereby allowing the reagents within the carrier gel to interact with the tissue section.

This process would have the advantage of skipping the delamination step, which bears the risk of fouling the gel strips inside the chiplet prior to stamping on the target substrate.

The sacrificial layer could also be PVA, or any other thin film which dissolves upon contact with a target substrate, with or without the target substrate having been moistened or impregnated with an agent that a) dissolves the sacrificial layer upon contact, and b) does not interfere with the intended purpose of the active ingredient being delivered by the chiplet. Further, the dissolved layer should not result in any byproducts which would be likely to interfere with the assay being so enabled.

### Combining A and B Barcoding Steps

Consolidating the A and B barcoding steps into one step, whether flow or stamp, would enable further workflow improvements. Chiplet-based processing offers a realistic path to achieving such a workflow improvement.

Consider two chiplets. Now mate them, perhaps with some kind of a transfer buffer between them to wet the surfaces. Let them incubate, interfaced, for some time. After barcodes have undergone diffusive exchange between the two chiplets, both chiplets should now contain both sets of barcodes, with overlapping A and B barcodes at the positions corresponding to the desired tixels (tixel elements, regions of tissue defined by the intersection of A and B channels).

The X-Chiplet could then when interfaced with tissue to produce usable spatial data.

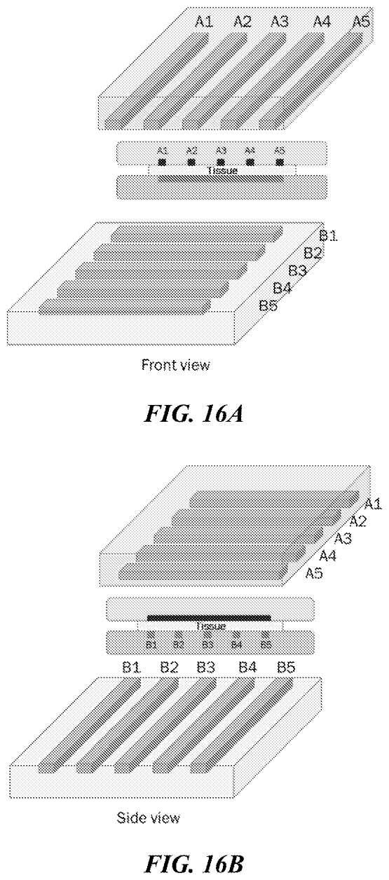

FIGS. 16A-16B show a configuration in which a tissue sample is positioned between an A and B chiplet. The protocol for such a method would be as follows. The upstream chemistry (tissue fixation, permeabilization, and reverse-transcription or Tn5 tagmentation, for example) could be performed in a 24-well plate on 8 or more tissue sections at once with 200-500 uL or reaction mix (versus 800-1600 on slides) and the washes would be much easier than on slides. They could then be wetted with ligation buffer and T4 Ligase (as in the sequential-stamp chiplet-based protocol described above), and sandwiched between an A and B chiplet and left to incubate overnight at 16° C. After incubation, the chiplets could be separated, and the entire mixture (chiplets and any residual tissue fragments) deposited into a Falcon tube and incubated with a digestion buffer (such as the lysis buffer used in DBiT, or in a standard lysis buffer used in bulk tissue dissociation protocols well known to those skilled in the art, e.g., those used in bulk RNA-seq extraction protocols). Afterwards the lysate could be collected, filtered, and subject to the standard DBiT-seq amplification and NGS library preparation protocol, perhaps with some adjustments made to allow for the larger volume of lysate likely to be collected in this manner. If tissue adheres to the chiplets and is difficult to disengage, it could be disrupted mechanically or ultrasonically, such as by placing the mixture inside of a vessel in an ultrasonic bath.

Strategies for Interfacing Chiplets with Target Substrates with Single or Multiple Regions of Interest

In some embodiments, multiple chiplets would be interfaced with a target substrate, resulting in multiple active areas, each targeting a distinct region of interest (ROI) on the target substrate. For example, FIG. 12 shows a glass slide with multiple tissue sections mounted on it in potentially arbitrary locations. Thus, each ROI could be located in any location on the slide (perhaps within an allowable zone, excluding the margins of the slide). In such an application, it would be necessary to mechanically compress each chiplet onto the glass slide in an arbitrary position and orientation (rotation around the axis perpendicular to the slide surface).

A first strategy for effectuating a flexible clamping mechanism to accommodate the non-uniform tissue spacing is to perform the following steps: (1) Generate a stitched micrograph of the 25×75 mm glass slide bearing the tissue sections as mounted on the slide; (2) Print out the image at 1:1 scale, e.g., with an inkjet printer; (3) Place a 25×75×3 mm cast acrylic or polycarbonate slab on the printout; (4) On top of the slab, and aligned with the printed image of the first region of interest, place the non-contact (blank) side of a chiplet such that the contact (barcode-bearing) side of the chiplet will align with the desired ROI upon inversion of the clear substrate; (5) Repeat step 4 for each desired ROI; (6) Peel the protective laminate off of the contact side of each chiplet; (7) Invert the entire assembly and place it upon the actual glass slide, such that each aligned chiplet interfaces on the glass slide in the desired ROI; (8) Press down upon the solid backing so as to effectuate the desired sealing pressure on each chiplet (typically 3-30 PSI). In the case of 8 chiplets each with approximately one half square inch of interface area, this would require a total uniform compression force of 12-120 pounds, which is achievable in a number of ways familiar to those skilled in the art of mechanical fixturing and clamping.

A second strategy for effectuating a flexible clamping mechanism to accommodate the non-uniform tissue spacing is to incorporate ferromagnetic nanoparticles in the two-part resin during mixing, prior to degassing and curing a microfluidic chip. Since the PDMS itself is magnetic, it can be compressed onto the target substrate by placing a magnetic element below each desired ROI, then placing one magnetic chiplet above each ROI.

### Alternatives to the Chiplet: Thin Strips of Barcoded Gel on Solid Substrate

In general there are an enormous number of combinations of substrate surface coatings and carrier gels, and that combination can be chosen which would generate the intended behavior (of gel either being retained in the gel carrier, or on the solid substrate). In the foregoing we envision barcoded gel being retained in the gel carrier. However, given the delamination discussion above, one might wonder whether an equally plausible strategy might be to use microfluidic chips to deposit barcoded gel on a solid substrate with the intent of keeping the gel on the substrate rather than inside the microfluidic chip.

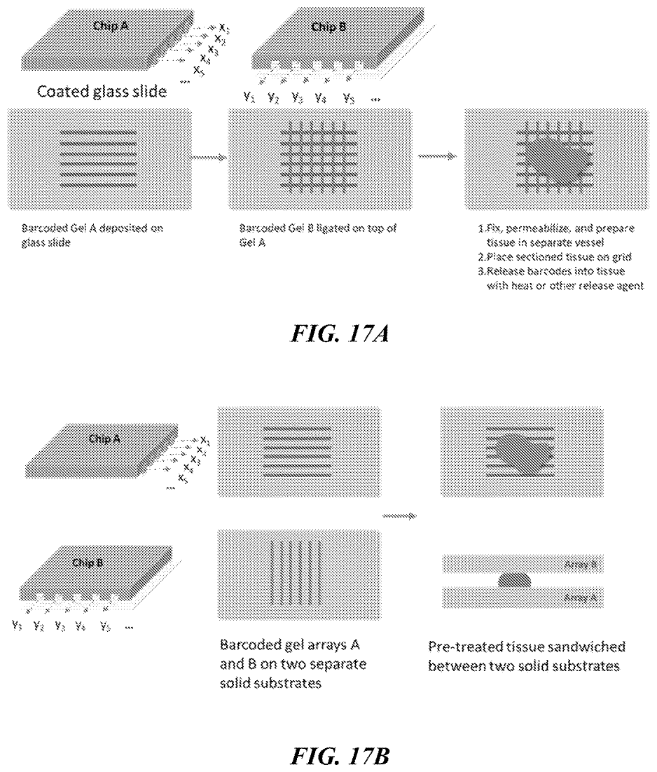

This approach enables two additional embodiments shown in FIGS. 17A and 17B. These embodiments can be preferred in cases where the chosen gel carrier materials and microfluidic device materials do not attach well to one another, making the barcoded gel difficult to retain inside the microfluidic device. In this case the substrate can be chosen to retain, rather than repel, the carrier gel. For example, poly-L-lysine coated slides are known to electrostatically bind to negatively-charged polymers such as DNA at pH 7.4. Therefore, a carrier gel also known to be negatively-charged at the chosen pH would also be likely to be retained by a PLL-coated glass slide. This approach was trialed in our lab, and deemed successful. However, the gel being retained within the microfluidic chip is advantageous where the walls of the chip selectively reduce the pore size between channels. Therefore, less lateral diffusion is observed with the barcodes being retained within the chip, rather than a flat substrate.

Improving Barcode Diffusion from Gel Matrix into Target Substrate Via Directed Diffusion

As previously discussed, chiplet-based processing delivers less active ingredient (e.g., fewer oligonucleotides) than does standard flow. While most of this is due to the low volume of carrier gel (compared to the volume of aqueous solution in standard flow) in contact with the active area of the target substrate, some might also be due to trapping of active ingredient inside the gel matrix, especially if the gel has pore sizes which are small relative to the active ingredient. For example, antibodies might be similar in size to the pore sizes of some gels, which could hinder their diffusion from parts of the carrier gel (especially those parts most distant vertically from the target substrate).

In such cases, directed diffusion can be employed to transport active ingredient from the carrier gel to the target substrate. Some examples of directed diffusion include electrophoresis, chemical gradients, and centrifugation.

Electric fields applied to conductive gels can set up directed diffusion gradients. For example, in gel electrophoresis, the negative charge of DNA (at pH's typical of homeostasis, i.e., pH 7.4) can promote directed diffusion towards the anode of an electric field generator. Let us consider, for the moment, solely those applications of the methods and devices described herein where the active ingredient has a negative or positive charge, or one or more components of the active ingredient has or have a negative or positive charge, or an additive element or elements to the active ingredient has or have, or can be induced (such as a charged molecule or molecules, or a molecule or molecules that have an induced charge in certain pH ranges) to have a negative or positive charge.

For example consider a carrier gel at pH 7.4 which is tasked with delivering single-stranded DNA (ssDNA) oligonucleotides to the target substrate (e.g., a tissue section). Now consider that the tissue section is mounted on an Indium-Tin-Oxide (ITO) and poly-D-lysine coated glass slide. The slide is conductive due to the ITO component of the surface coating. Meanwhile the gel carrier is made of PDMS with an embedded mesh of electrodes to help spread the electric field uniformly in the area above the gel strips inside the carrier.

Since ssDNA develops a negative charge at this pH, placing a cathode in contact with electrodes embedded in the PDMS structure of the gel carrier and an anode in contact with the ITO-coated conductive slide underneath the tissue should drive oligonucleotide barcodes out of the gel and into the tissue.

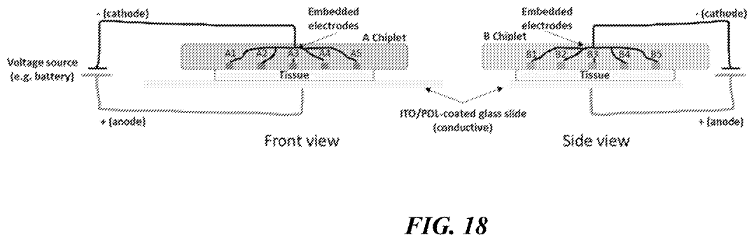

FIG. 18 shows an application of electrophoresis to transport active ingredients from the gel carrier into the target substrate. The left and right portions of FIG. 18 depict stamping with A and B chiplets, respectively.

Exemplary Assays (Other than DBiT-Seq)

Chiplet-based processing can also be used to support other types of assays besides DBiT, including those intended to multiplex tissue treatment conditions. Such methods and systems were described in a flow-based processing context in U.S. Ser. No. 17/960,007, SYSTEM AND METHODS FOR HIGH THROUGHPUT SCREENING OF TISSUE PREPARATION CONDITIONS, a non-provisional filing by AtlasXomics inventors including some of the present inventors. In the chiplet-based processing described there, all protocol steps remain the same except that the flow steps performed using microfluidic devices are replaced with stamping steps using chiplets as described herein.

For example, an antibody titration was described in that disclosure which taught how to treat the target substrate (a tissue section) with different concentrations of antibody by flowing different concentrations of antibody in some or all of the lanes of a 50-channel microfluidic device in order. In a chiplet-based processing flavor of such an assay, a chiplet could be fabricated by loading gelatin or some other carrier gel with antibody into a chip, flowing the gel forward into the active area and fixing it in place, de-laminating the chiplet from the flow substrate, then stamping it onto the target substrate (i.e., the tissue section). In other words, the active ingredient could be one or more of any of a number of reagents intended to react with a target substrate, including oligonucleotides, antibodies, enzymes, acids or bases, chromogenic substances (such as peroxidases or other enzymatically-acting staining agents). The active ingredients can all have the same concentration or different concentrations according to the goals of the assay supported by the chiplet stamping process.

Time could also be supported as a process variable by controlling the timing of release of active ingredient from the gel carrier into the target substrate. For example, a gel made of polymers with photocleavable crosslinkers would revert to solution upon illumination by ultraviolet radiation, thereby rapidly releasing the active ingredients previously trapped in the gel matrix. By selectively irradiating subsections of the chiplet gel array with properly arranged ultraviolet illuminators, the experimenter would be free to expose different regions of the target substrate to time-varying concentrations of active ingredient in a manner that would be difficult or impossible to do with a standard flow device.

A tissue section with two or more distinct cellular niches could benefit from varying time as a process variable. The two distinct regions can include brain cortex vs hippocampus, kidney medulla vs cortex, or any tissue section with different areas that have different optimal permeabilization conditions. These areas are clearly visible in DBiT runs as areas with high and low fragment counts.

In a use case where we wish to permeabilize three sub-regions of the tissue with different permeabilization times N1, N2, and N3. This might be of particular use where N1 has some very fibrous tissue and is tough to access, N2 is a little easier, and N3 has the most accessible tissue with sparse extracellular architecture. In order to homogenize reagent accessibility across these different niches, for the first niche N1 we wish to permeabilize for T1=15 minutes, the second niche N2 for T2=10 minutes, and N3 for T3=5 minutes. The following procedure could be used to accomplish these permeabilization times: (1) Prepare a monomer+cross-linker style of gel, with the cross-linker being photocleavable (e.g., by UV light above a certain intensity threshold). (2) Prepare a liquid of this gel loaded with a permeabilization agent (e.g., 5% or more gelatin in water, with 1% of the water being Triton X-100. When crosslinked, the active ingredient will diffuse only slowly out of the gel, so that the tissue section won't permeabilize much until the gel above it is illuminated. When de-crosslinked by UV light, the active ingredient will be rapidly delivered to the tissue section. (3) Mold the loaded gel into a square, approximately the size of the tissue section. (4) Using a photomask+collimated UV light source, or a digital micromirror device (DMD), illuminate only the area corresponding to niche N1 at time T=0. The DMD has spatial resolution below 1 um at UV frequencies. The photomask+collimated light source will likely have worse resolution (since it won't be in direct contact with the sample to be illuminated, but will be separated by a millimeter or so, allowing light to refract around the edges). (5) After 5 minutes, illuminate only niche N2. (6) After 5 more minutes, illuminate only niche N3. (7) Wait 5 minutes, then wash the entire assembly in warm (37° C.) NEB buffer. The shape of the mask or the patterns illuminated by the DMD could be selected by the user based on imaging of the sample or an adjacent sample.

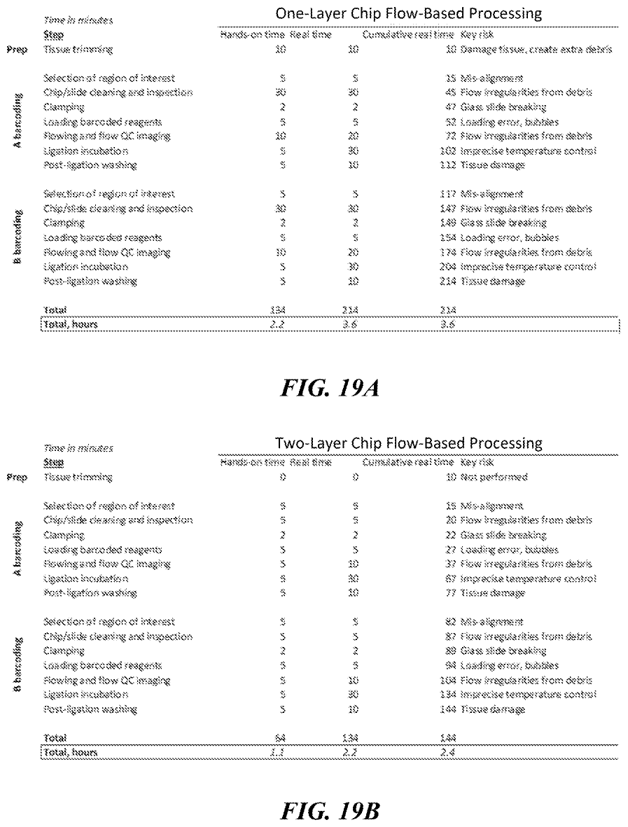

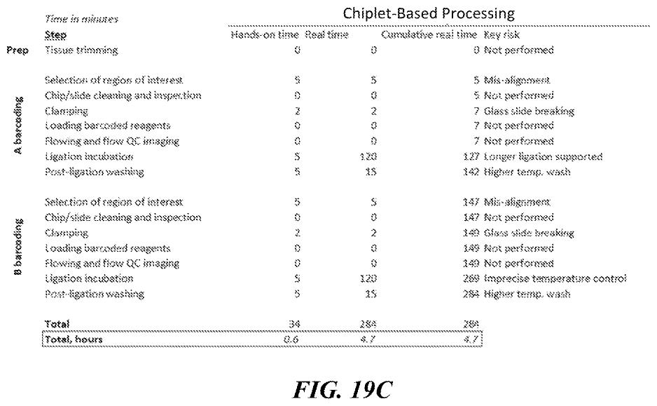

FIGS. 19A-19C show relative cycle time data for DBiT operations with one layer microfluidic chip flow-based processing, two layer microfluidic chip flow-based processing and chiplet-based DBiT processing.

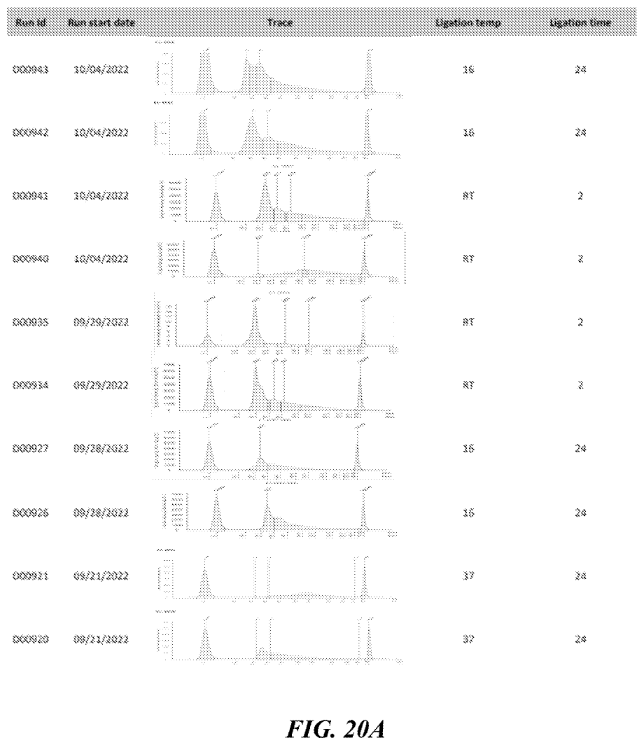

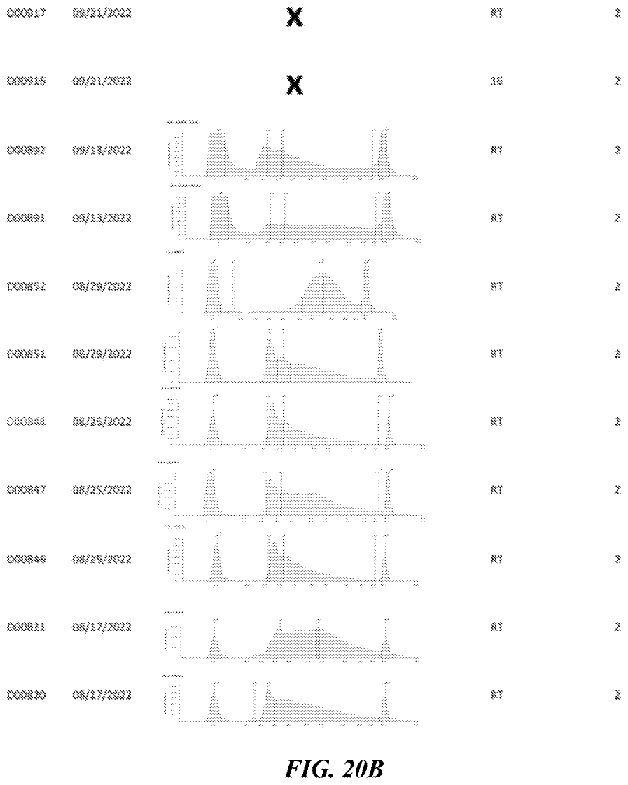

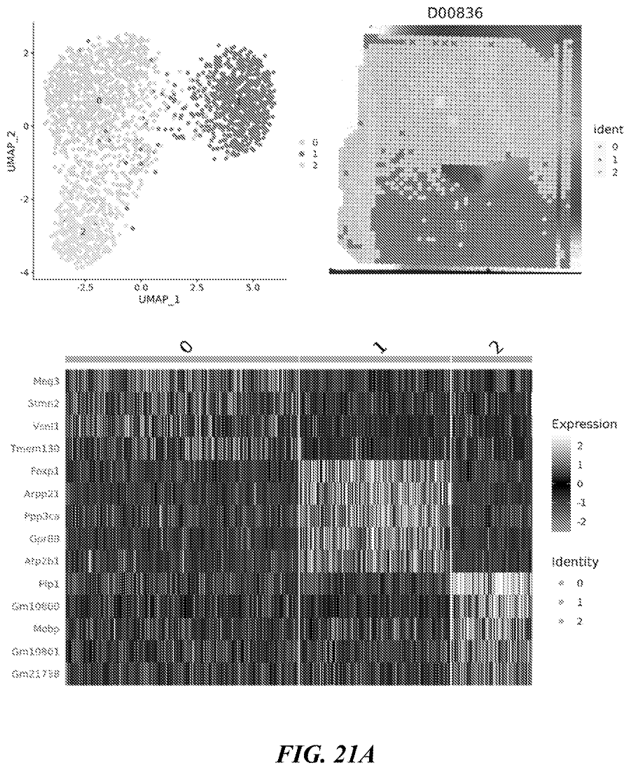

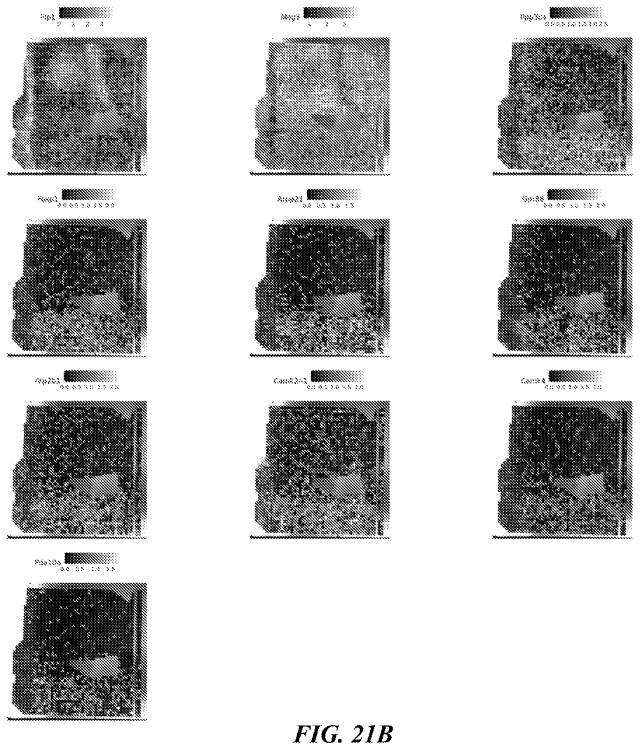

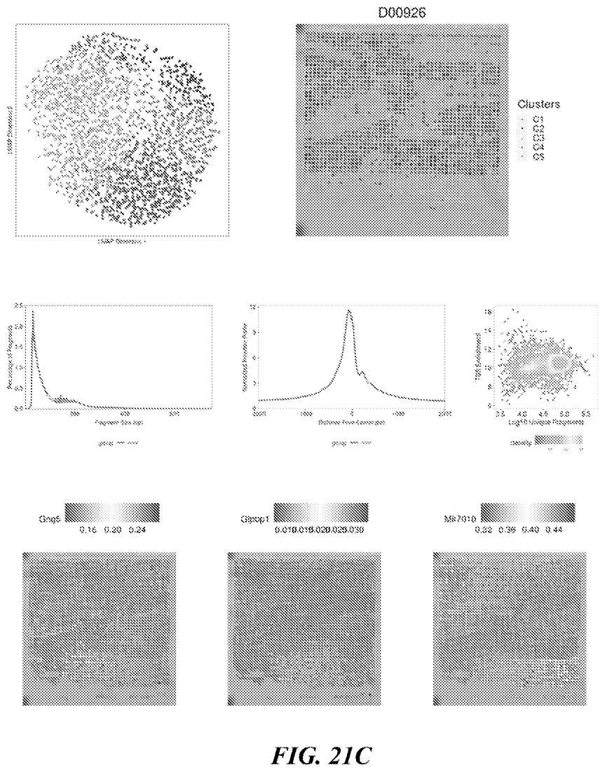

FIGS. 20A-20B show electropherograms for a number of different chiplet-based DBiT runs. FIGS. 21A-21C show exemplary sequenced datasets generated using chiplet-based processing.

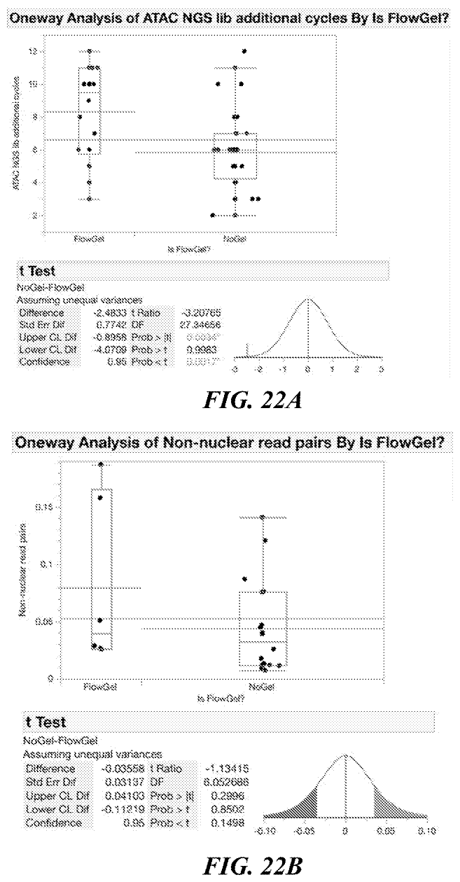

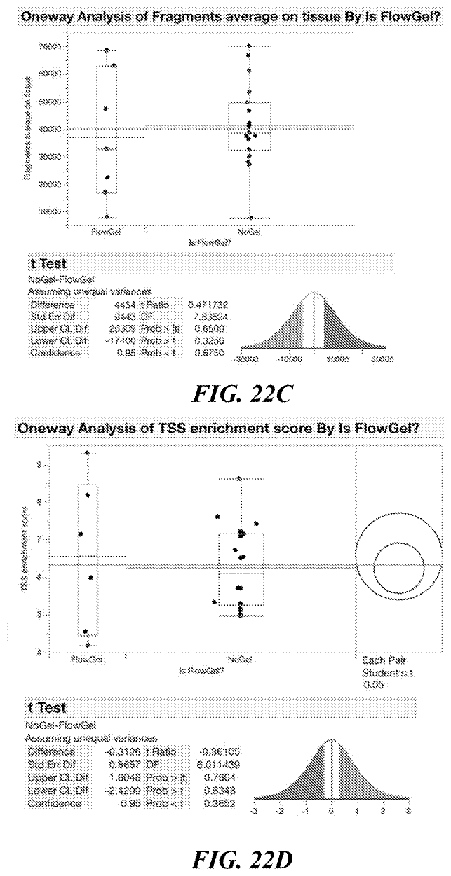

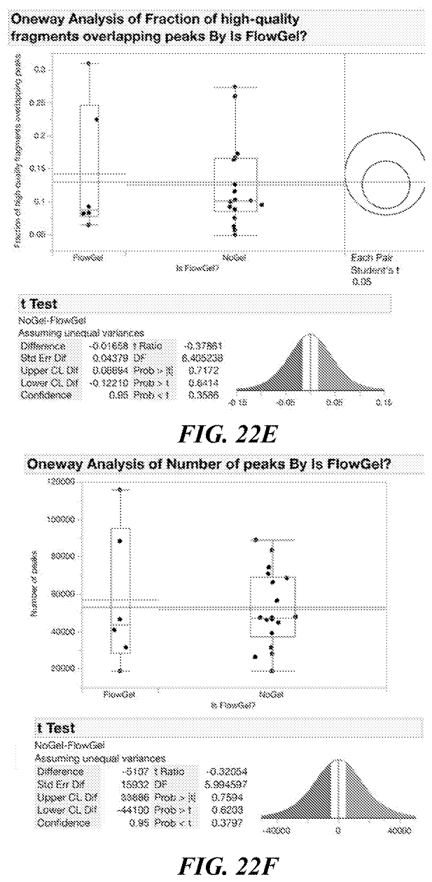

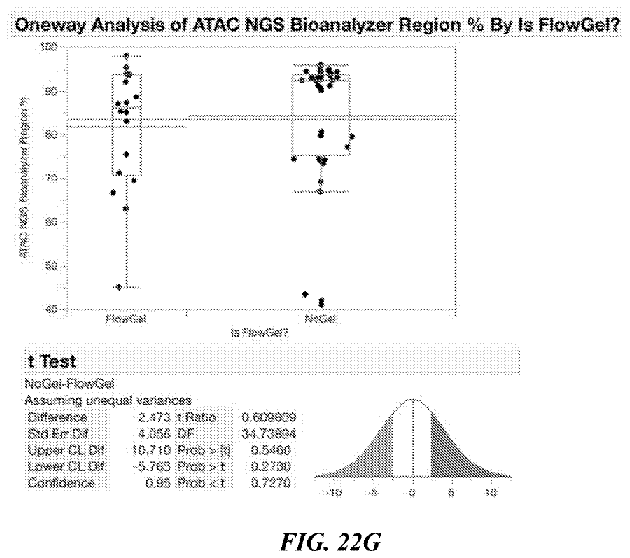

FIGS. 22A-22G illustrate comparisons of chiplet-based runs and standard DBiT-ATAC-seq runs performed on tissue sections from the same specimen blocks. In these figures, the term FlowGel refers to chiplet-based processing. NGS ATAC library QC and post-sequencing metrics are compared for chiplet-based versus “NoGel” groups. Tests comparing group means show no detrimental impact of gel code stamping on QC metrics and NGS output versus standard workflow. Analysis excludes outlier chiplet-based run DBiT 851 which received extraordinarily high sequencing depth and looks excellent in raw sequencing metrics even though it has poor spatial clustering data. It is likely the result of an improper delamination that should have been rejected by visual quality control; however as an early proof of concept it was deemed worth attempting anyway. Analysis combines both 10 um and 25 um spatial runs. Dots: individual DBiT run values. Red lines: box-and-whisker plots showing quantiles, median, and expected variance (1.5*interquartile range, or minimum and maximum values where no outliers fall outside expected variance). Green lines: group means. Black line: grand mean of all plotted values. X-axis size proportional to number of runs from group included in analysis: Post-sequencing metrics: n=6 for FlowGel, n=18 for standard flow; ATAC NGS library QC metrics: n=18 for FlowGel, n=40 for standard flow. Means comparisons: Student's two-tailed t-test assuming unequal variances.

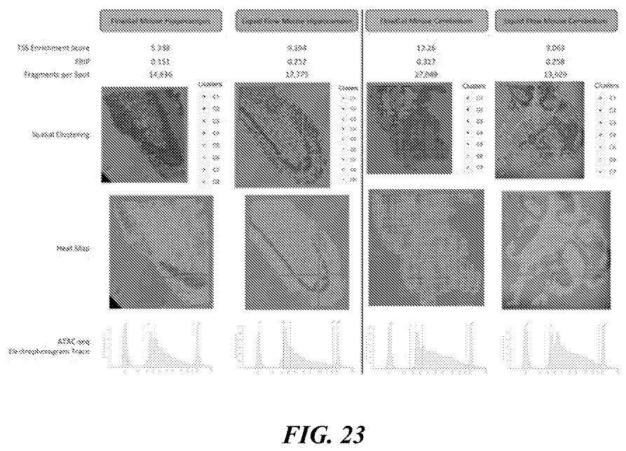

FIG. 23 shows a comparison of chiplet based (FlowGel) and flown liquid over tissue based spatial-ATAC-DBiT-seq.

FIG. 24 demonstrates the use of these chiplets for co-profiling spatial whole transcriptome and spatial ATAC on the same tissue section.

FIG. 25 demonstrates that these chiplets can be used on substrates different than tissue sections. Specifically, these were spatial ATAC DBiTs of cells printed on top of glass slides.

### List of Terms

In what follows we will refer to the existing family of ingredient-printing methods as “flow-based” methods, to distinguish them from the “chiplet-based” method described here. This stamping method forms ingredient-laden gel strip arrays inside of microfluidic chips by flowing on a blank substrate, then later places the array in contact with the substrate long enough for the ingredient in the gel to interact with the substrate. The methods call for the following key components with exemplary but not limiting embodiments:
1. Active-ingredient: the material to be deposited on a target substrate with a defined spatial pattern
2. Active ingredient array: the parallel features full of active ingredient which enables the assay supported by this method. Examples: DBiT-seq, T-Recs.
3. End user—the person or people stamping the active ingredient array onto the target substrate.
4. Gel carrier/chiplet (potentially the trade name)—the device into which the ingredient-bearing gel is loaded, and the consumable delivered to the end user.
   a. One preferred embodiment is a microfluidic chip
      i. AtlasXomics Suburbia A/B chip at 5, 10, 25, 50 um resolution
      ii. AtlasXomics Portal A/B chip at 25 um resolution
      iii. FlowGel SuperChip at 10, 15, 25 and 50 um resolution
      iv. Wafer-sized MotherChip
   b. The gel carrier's job is to deliver active ingredient to a target substrate.
   c. In some preferred embodiments the pattern consists of dozens or hundreds of parallel, thin lines, with width and pitch spacing of 25 um or less).
   d. In other embodiments the pattern consists of several or tens of so-called “millifluidic” chambers, spanning a larger area of the target substrate (e.g., 1×1 mm, or 1×2 mm, or similar shapes & sizes)
5. Flow substrate
   a. such as one made of glass, with or without a hydrophobic coating, such as commercially available products like RainX™
   b. or made of silicon, with or without a hydrophobic coating, such as commercially available products like RainX™
   c. or one made of Teflon, PEEK, or other hydrophobic polymer unlikely to adsorb or absorb the carrier gel, or any of a number of other highly non-adsorbent polymeric substrates
   d. or, in a preferred embodiment, one made of a flexible plastic sheet, such as polyethylene (PET) or polycarbonate (PC) with thickness of 100 um, 200 um, or less than 100 um. One key advantage of the flexible sheet is that it can be peeled off of the gel carrier without bending the gel carrier itself, which results in much better retention of carrier gel inside the gel carrier, as compared to peeling the gel carrier off of the flow substrate (such as must be done if the flow substrate is rigid, including if it is a glass slide or other rigid material).
6. Target substrate, to which active ingredient is to be delivered via stamping after delamination of the gel carrier from the blank flow substrate. In the case of DBiT-seq the target substrate is a thin (10 um or less) mounted tissue section on a coated glass slide. In other cases the target substrate could be a thicker tissue sample (e.g., 10 um or above, up to 100 um, cut on a vibratome), a tissue block (such as that recovered from a tissue biopsy), printed cells, organoids, plants, an absorbent material for paints or other inks, the outer layer of an animal (such as the skin of the human arm),
7. Carrier gel material impregnated with active ingredient, flowed on the flow substrate through the microfluidic chip in liquid form, embedded into place inside the microfluidic chip (preferably through change in temperature or some other method which does not rely on addition of an external catalyst, since the gel is inaccessible until delaminated), delaminated from the flow substrate, with enough of the gel being retained by the chip (rather than the substrate) to support later application onto and delivery of impregnated reagent into the target substrate. Here is a list of potentially compatible materials with which to fabricate the carrier gel material:
   a. Water-absorbent gels (“hydrogels”). As in, “three dimensional cross-linked polymer systems capable of imbibing large amounts of water or biological fluids between their polymeric chains to form aqueous semi-solid/solid gel networks.”
      i. Physical/reversible hydrogels
         1. Thermally controlled
         a. Gelatin
         b. Pectin
         c. Poloxamer
         d. PL(G)A-based triblock gelators
         e. Poly (N-isopropylacrylamide) (PNIPAM)-poly (phosphorylcholine)-PNIPAM
         f. Asymmetric triblock copolymer formed of PEG, PLA, and poly (L-glutamic acid)
         g. chitosan solutions and glycerol-2-phosphate
         h. hydroxypropylcellulose
         i. thermosensitive methylcellulose to thermally gel aqueous alginate solution blended with various salts such as CaCl2), Na2HPO4, and NaCl
         2. Ionically bound
         a. A mixture of quaternized chitosan (N-[(2-hydroxy-3-trimethylammonium) propyl]chitosan chloride (HTCC)) and glycerophosphate (GP)
         b. anionic (methacrylic acid (MAA)) and cationic (dimethylaminoethyl methacrylate (DMAEMA)) polymers coated hydroxyethyl methacrylate-derivatized dextran microspheres
         3. Hydrogen-bonding mediated
         a. PVA
         b. PVA in combination with other polymers such as chitosan (“cryogel”)
         i. PVA cryogel containing minocycline and gentamycin,
         c. blend of two or more natural polymers such as hyaluronic acid-methylcellulose, gelatin-agar, and starch-carboxymethyl cellulose
         d. composite cryogels of metronidazole with carboxymethyl tamarind kernel polysaccharide and PVA
         4. Gels based on stereocomplexation
         a. polylactide blocks with L- and D-stereochemistry
         b. isotactic and syndiotactic poly(methyl methacrylate) (PMMA)
         5. Gels based on supramolecular chemistry
         a. a reversible hydrogel complex between PEO polymers and α-cyclodextrins
         b. PPO-grafted dextran into a hydrogel with β-cyclodextrin
         c. PEO-poly(R-3-hydroxybutyrate) (PHB)-PEO triblock copolymers complexed with α-cyclodextrin to form a self-assembled hydrogel network
      ii. Chemical/permanent gels that deliver active ingredient via diffusion into the target substrate, rather than gel dissociation.
         1. Cross-linked gels
         a. dialdehyde such as glyoxal and particularly glutaraldehyde46 forms covalent imine bonds with the amino groups of chitosan via Schiff reaction
         b. dextran-tyramine and hyaluronic acid-tyramine covalently bonded by using horseradish peroxidase (HRP) and hydrogen peroxide (H2O2) as cross-linkers
         c. Genipin to cross-link chitosan or gelatin, or amino-terminated groups containing molecules such as PEG, N,O-carboxymethyl chitosan, and BSA
         2. Polymer-polymer cross-linking or hybrid polymer networks (HPN)
         a. cross-linking of vinyl sulfone-functionalized dextrans with thiolated PEG
         3. Photo cross-linking
         a. azide groups (—N3) incorporated into polymeric chain of chitosan
         b. thermo-sensitive chitosan-pluronic hydrogel, where both the polymers were functionalized with photo sensitive acrylate groups (CH2═CHCOO—) by UV irradiation
         c. modifying chitosan with photoreactive azidobenzoic acid and PEG with arginylglycylaspartic acid peptide
         4. Enzymatic cross-linking
         a. gelatin hydrogels cross-linked by microbial TG (mTG)
         b. HRP catalyzed injectable tyramine modified hyaluronic acid (HA-Tyr)
         c. enzymatically cross-linked injectable hydrogel was developed from chitosan derivatives, chitosan-glycolic acid, and phloretic acid using HRP and H2O2
         5. Interpenetrating networks (IPNs)

The foregoing descriptions of various embodiments have been presented only for purposes of illustration and description. They are not intended to be exhaustive or to limit the present system to the forms disclosed. Accordingly, many modifications and variations will be apparent to practitioners skilled in the art. Additionally, the above disclosure is not intended to limit the present system.

What is claimed is:

1. A method, comprising:
securing a flow substrate directly to a microfluidic chip comprising a plurality of channels;
flowing a first reagent embedded in a first gel carrier material through a first channel of the plurality of channels and a second reagent embedded in a second gel carrier material through a second channel of the plurality of channels;
adjusting one or more material properties of the first and second gel carrier materials disposed within the plurality of channels to restrict further movement of the first and second reagents within the microfluidic chip and to form a chiplet.

2. The method of claim 1, further comprising:
separating the flow substrate from the chiplet.

3. The method of claim 1, further comprising:
cutting the chiplet into a plurality of pieces to produce one or more chiplets that includes at least a first chiplet, wherein the first chiplet includes a first portion of the first channel and a second portion of the second channel, wherein the first and second portions of the first and second channels included in the first chiplet extend from a first end of the first chiplet to a second end of the first chiplet.

4. The method of claim 3, further comprising:
inspecting the one or more chiplets for defects; and
disposing of any of the one or more chiplets determined to have a defect during the inspection.

5. The method of claim 3, wherein the first channel is parallel to the second channel and the first and second channels extend linearly from the first end of the first chiplet to the second end of the first chiplet.

6. The method of claim 3, wherein cutting the chiplet into a plurality of pieces produces a second chiplet and the first chiplet.

7. The method of claim 3, further comprising:
securing the first chiplet to a substrate of interest; and
guiding the first reagent and the second reagent to at least a first isolated area and a second isolated area of the substrate of interest.

8. The method of claim 1, wherein adjusting the one or more material properties of the first and second gel carrier materials comprises reducing a temperature of the first and second gel carrier materials to increase a viscosity of the first and second gel carrier materials.

9. The method of claim 1, further comprising:
securing the chiplet to a substrate of interest; and
guiding the first reagent and the second reagent to at least a first isolated area and a second isolated area of the substrate of interest.

10. A method, comprising:
Applying a chiplet to a substrate of interest, wherein the chiplet comprises a plurality of parallel channels extending from a first end of the chiplet to a second end of the chiplet, opposite the first end, the plurality of channels comprising a first channel filled with a first reagent embedded in a first gel carrier material and a second channel filled with a second reagent embedded in a second gel carrier material;
securing the chiplet to the substrate of interest;
increasing a temperature of the chiplet to allow the first and second reagents to flow on to and interact with the substrate of interest; and
removing the chiplet from the substrate of interest after a predetermined incubation time.

11. The method of claim 10, wherein applying the chiplet to the substrate of interest comprises applying a plurality of chiplets to different regions of the substrate of interest.

12. A chiplet, comprising:
a first substrate defining a plurality of channels, wherein the plurality of channels extends from a first end of the first substrate to a second end of the first substrate that is opposite the first end;
a first reagent embedded in a gel carrier material that fills a first channel of the plurality of channels;
a second reagent embedded in the gel carrier material that fills a second channel of the plurality of channels; and
a second substrate covering the plurality of channels.

13. The chiplet of claim 12, wherein a temperature of the chiplet increases a viscosity of the gel carrier material above a threshold value that restricts movement of the first and second reagents within the first and second channels.

14. The chiplet of claim 12, wherein the gel carrier material is freeze dried to restrict movement of the first and second reagents within the first and second channels.

15. The chiplet of claim 12, wherein the second substrate covering the plurality of channels is removed prior to stamping onto a substrate of interest.

16. The chiplet of claim 15, wherein after securing the chiplet to the substrate of interest, the active reagent is released by reverse crosslinking the gel matrix via heat.
